(19) United States
(12) Patent Application Publication
(10) Pub. No.: US 2013/0313484 A1
(43) Pub. Date: Nov. 28, 2013

(54) ANTI-COUNTERFEITING FIBER, ANTI-COUNTERFEITING PAPER CONTAINING ANTI-COUNTERFEIT FIBER AND MANUFACTURE METHOD THEREOF

(71) Applicant: Xianlin Sun, Shanghai (CN)

(72) Inventor: Xianlin Sun, Shanghai (CN)

(73) Assignee: SHANGHAI KOS SECURITY PAPER TECHNOLOGY CO., LTD., Shanghai (CN)

(21) Appl. No.: 13/979,126

(22) PCT Filed: Jan. 11, 2012
(86) PCT No.: PCT/CN2012/070243

§ 371 Date: Jul. 10, 2013

(30) Foreign Application Priority Data
Jan. 11, 2011 (CN) 201110005037.X
Jan. 11, 2011 (CN) 201120007458.1

(51) Int. Cl. D02G 3/34; D02G 3/44; B42D 15/00; D01D 10/00

(52) U.S. Cl. CPC D02G 3/346; D01D 10/00; D02G 3/447; B42D 15/0026
USPC 252/408.1; 28/226; 428/370

(57) ABSTRACT

An anti-counterfeiting fiber, anti-counterfeiting paper containing the anti-counterfeiting fiber, and manufacture method thereof. The anti-counterfeiting fiber is a slice or part of a slice cut along a cross-section of a strip-shaped fiber, wherein the strip-shaped fiber includes a specific structure along the length direction providing anti-counterfeiting characteristics. Structures manufactured using the principles of the process have better orientation than structures manufactured using conventional processes for manufacturing anti-counterfeiting fiber during the paper manufacturing process and can form more unique visual characteristics.

### TECHNICAL FIELDS

This invention belongs to an anti-counterfeit technical field, especially to an anti-counterfeiting fiber, an anti-counterfeiting paper containing the anti-counterfeiting fiber, and manufacture methods for the anti-counterfeiting fiber and the anti-counterfeiting paper.

### TECHNICAL BACKGROUND

There are two main methods to manufacture anti-counterfeiting fibers currently, one method is to make fine filament via spinning method, and then to cut shorts along length direction, the fiber's diameter is generally less than 100 μm and cut length is generally between 3 and 10 mm, seldom shorter than 1 mm; visual characteristics of the fiber made via this process are the same along fiber length direction. Other method is to print plane pattern on plastic film, and then to cut the plastic film, but visual characteristics of the formed fiber have certain limitation because of the plane structure of the film. In these two methods mentioned above, because of limitations of process principles, the manufactured anti-counterfeiting fibers are in strip or plane forms, the visual characteristics of strip-shaped anti-counterfeiting fiber are very limited and its length is also limited, and when it is mixed into paper, its orientation problem will be an obstacle for appearing its visual characteristics. Though the plane-shaped anti-counterfeiting fiber has good orientation when it is mixed into paper, its visual characteristics are very limited.

### SUMMARY OF THE INVENTION

The purpose of this invention is to offer an anti-counterfeiting fiber made via slice-cutting process and its manufacture method, good orientation could be obtained and more unique visual characteristics could be formed when said anti-counterfeiting fiber is mixed into paper.

The purpose of this invention is realized by the ways as follows:

An anti-counterfeiting fiber, characterized in that: said anti-counterfeiting fiber 1 is a slice 4 or a part of slice 4 formed by cutting a strip-shaped fiber 2 along its cross-section 3, the cross-section 3 is a transversal surface 3₁ or oblique section 3₂, said strip-shaped fiber 2 comprises a specific structure along its length direction providing anti-counterfeiting characteristics to said slice 4 or the part of slice 4, said slice 4 or the part of slice 4 has said anti-counterfeiting characteristics, said transversal surface 3₁ refers to the cross-section perpendicular to longitudinal axis of the strip-shaped fiber 2, said oblique section 3₂ refers to the cross-section aslant-intersecting longitudinal axis of the strip-shaped fiber 2, said part of slice 4 refers to a residual part after removing a support part X from the slice 4.

This invention adopts cutting process to realize anti-counterfeiting characteristics for the anti-counterfeiting fiber, during designing anti-counterfeiting characteristics of the anti-counterfeiting fiber, corresponding to the specific structures of the strip-shaped fiber 2, it can be a whole slice 4, and also can be a part of slice 4, which is a residual part of the slice 4 with its support part X removed.

For the slice 4 with a support part X, there are two functions for the slice 4 with the support part X designed in it, one is for easier to prepare the strip-shaped fiber 2 and the other is for easier to cut. For example, if the shape of the anti-counterfeiting fiber 1 is in hollow ring, then the extruded strip-shaped fiber 2 should be a solid round bar, that is easier for cutting it into slice 4 than cutting hollow round pipe, after cutting solid round bar into slice then it can be managed to remove its central material and leave the round ring with anti-counterfeiting characteristics. There are many methods for removing, which will be discussed in detail in embodiments.

Said anti-counterfeiting fiber in this invention can be in shapes of line or slice.

Via designing specific structures of the strip-shaped fiber and taking a process of cutting slices, the prepared anti-counterfeiting fiber has the visual characteristics, which cannot be realized by current spinning methods, and because the anti-counterfeiting fiber shall be mixed into paper, the slice shall be very thin, such kind of anti-counterfeiting technology will be more difficult to fake, and also can generate many visual characteristics that are difficult to imitate via printing inks.

Furthermore, maximum length of cutting surfaces 5 of said slice 4 is between 0.5 mm 15 mm; and/or height of said slice 4 or said part of slice 4 is not over than 300 μm. Said maximum length refers to the maximum straight line distance between two points on plane surface. The anti-counterfeiting fiber of this invention has such characteristic because of adopting the cutting process.

Furthermore, a ratio of the maximum length of cutting surfaces 5 of said slice 4 to the height of said slice 4 is over than 5, or a ratio of the maximum length of cutting surfaces 5 of said slice 4 to the height of said part of slice 4 is over than 5. This is an inherent characteristic of the anti-counterfeiting fiber made via cutting method, because of such characteristic, the anti-counterfeiting fiber with designed specific structures is completely different with that made via spinning method, thus the anti-counterfeiting purpose is realized.

Furthermore, said slice 4 has two cutting surfaces 5 and these two cutting surfaces 5 are parallel with each other. This characteristic is for further defining the characteristic of cutting process.

Furthermore, said anti-counterfeiting fiber is characterized in that: when said anti-counterfeiting fiber 1 is mixed into paper, at least one of the cutting surfaces 5 of said slice 4 is parallel to surface of said paper. This characteristic reveals that the visual characteristics of the anti-counterfeiting fiber in this invention is the visual characteristics of cross-section 3 of the strip-shaped fiber 2, but the anti-counterfeiting characteristics of anti-counterfeiting fiber made by traditional spinning process has visual characteristic along length direction of the fiber, with very small transversal surface, generally less than 70 μm in size, so its transversal surface cannot be observed.

Furthermore, the above anti-counterfeiting fiber is characterized with that: said specific structure has two or more material parts distributed on the cross-section 3 of the strip-shaped fiber 2.

Effect of this invention is that it can offer many visual characteristics of anti-counterfeiting fiber, which cannot be formed or are difficult to be realized by current spinning process, these unique visual characteristics will be explained in more details in following embodiments.

### DESCRIPTION OF THE FIGURES

FIGS. 1a and 1b respectively show relationships of strip-shaped fiber and the slice under two situations, FIG. 1a shows a slice vertically cut from a strip-shaped fiber and FIG. 1b shows a slice slantingly cut from a strip-shaped fiber.

FIGS. 2a-1, 2a-2, 2b-1, 2b-2, 2c-1 and 2c-2 respectively show the anti-counterfeiting fibers with a single material part and in shape of non-occluded circular-arc form with different arc-radius, and their slices.

FIGS. 3a-1, 3a-2, 3b-1, 3b-2, 3c-1 and 3c-2 respectively show the anti-counterfeiting fibers with a single material part and in shape of non-occluded bended form, and their slices.

FIGS. 4a and 4b respectively show the anti-counterfeiting fiber with a single material part and in shape of non-occluded circular-arc form in same arc-radius with radian over than π but less than 2π, and its slice.

FIGS. 5a and 5b respectively show the anti-counterfeiting fiber with a single material part and in shape of circular ring form in same arc-radius, and its slice.

FIGS. 6a-1, 6a-2, 6b-1, 6b-2, 6c-1, 6c-2, 6d-1, 6d-2, 6e-1, 6e-2, 6f-1 and 6f-2 respectively show the anti-counterfeiting fibers with a single material part and in shape of oval ring form and polygon ring form, and their slices.

FIGS. 7a, 7b and 7c respectively show anti-counterfeiting fibers with several material parts and in shape of straight line form.

FIGS. 8a-1, 8a-2, 8b-1, 8b-2, 8c-1, and 8c-2 respectively show anti-counterfeiting fibers with several material parts and in shape of circular-arc form with radian equal to or less than π, and their slices.

FIGS. 9a-1, 9a-2, 9b-1, 9b-2, 9c-1, 9c-2, 9d-1 and 9d-2 respectively show anti-counterfeiting fibers with several material parts and in shape of circular-arc form with radian over than π but less than 2π, and their slices.

FIGS. 10a-1, 10a-2, 10b-1 and 10b-2 respectively show anti-counterfeiting fibers with several material parts and in shape of non-occluded circular-arc form in different arc-radius, and their slices.

FIGS. 11a-1, 11a-2, 11b-1 and 11b-2 respectively show anti-counterfeiting fibers with several material parts and in shape of non-occluded bended form, and their slices.

FIGS. 12a-1, 12a-2, 12b-1, 12b-2, 12c-1 and 12c-2 respectively show anti-counterfeiting fibers with several material parts and in shape of circular ring form with same arc-radius, and their slices.

FIGS. 13a and 13b respectively show the anti-counterfeiting fiber with several material parts and in shape of ring form with different arc-radius, and their slices.

FIGS. 14a-1, 14a-2, 14b-1, 14b-2, 14c-1 and 14c-2 respectively show anti-counterfeiting fibers with several material parts and in shape of polygon ring form, and their slices.

FIG. 15 shows a straight-line anti-counterfeiting fiber with two material parts.

FIG. 16 shows an anti-counterfeiting fiber with two material parts and in shape of circular-arc form with radian equal to or less than π.

FIGS. 17a and 17b respectively show the anti-counterfeiting fiber with two material parts and in shape of circular-arc form with radian over than π but less than 2π, and their slices.

FIGS. 18a-1, 18a-2, 18b-1 and 18b-2 respectively show anti-counterfeiting fibers with two material parts and in shape of non-occluded circular-arc form with different arc-radius, and their slices.

FIGS. 19a and 19b respectively show the anti-counterfeiting fiber with two material parts and in shape of non-occluded bended form, and their slices.

FIGS. 20a and 20b respectively show the anti-counterfeiting fiber with two material parts and in shape of circular ring form with same arc-radius, and their slices.

FIGS. 21a and 21b respectively show the anti-counterfeiting fiber with two material parts and in shape of ring form with different arc-radius, and their slices.

FIGS. 22a-1, 22a-2, 22b-1, 22b-2, 22c-1 and 22c-2 respectively show anti-counterfeiting fibers with two material parts and in shape of polygon ring form, and their slices.

FIG. 23 shows a transversal surface along length direction of an anti-counterfeiting fiber with P combination of two material parts.

FIG. 23-1 shows a circular ring form plan appeared on cutting surface of an anti-counterfeiting fiber with P combination.

FIG. 24 shows a transversal surface along length direction of an anti-counterfeiting fiber with Q combination of two material parts.

FIG. 24-1 shows a circular ring form plan appeared on cutting surface of an anti-counterfeiting fiber with Q combination.

FIG. 25 shows a transversal surface along length direction of an anti-counterfeiting fiber with R combination of two material parts.

FIG. 25-1 shows a circular ring form plan appeared on cutting surface of an anti-counterfeiting fiber with R combination.

FIG. 26 shows a transversal surface along length direction of an anti-counterfeiting fiber with M combination of two material parts.

FIG. 27 shows a transversal surface along length direction of an anti-counterfeiting fiber with several P combinations.

FIG. 27-1 shows a disc-form plan appeared on cutting surface of an anti-counterfeiting fiber with several P combinations.

FIG. 28 shows a transversal surface along length direction of an anti-counterfeiting fiber with several Q combinations.

FIG. 28-1 shows a disc-form plan appeared on cutting surface of an anti-counterfeiting fiber with several Q combinations.

FIG. 29 shows a transversal surface along length direction of an anti-counterfeiting fiber with several R combinations.

FIG. 29-1 shows a circular ring form plan appeared on cutting surface of an anti-counterfeiting fiber with several R combinations.

FIG. 30 shows a transversal surface along length direction of an anti-counterfeiting fiber with several parallel M combinations.

FIG. 31 shows a straight-line anti-counterfeiting fiber with three material parts.

FIGS. 32a and 32b show the anti-counterfeiting fiber with three material parts and in shape of circular-arc form with radian being equal to or less than π, and its slice.

FIGS. 33a and 33b show the anti-counterfeiting fiber with three material parts and in shape of circular-arc form with radian over than π but less than 2π, and its slice.

FIGS. 34a and 34b show the anti-counterfeiting fiber with three material parts and in shape of non-occluded circular-arc form in different arc-radius, and its slice.

FIGS. 35a and 35b show the anti-counterfeiting fiber with three material parts and in shape of non-occluded bended form, and its slice.

FIGS. 36a and 36b show the anti-counterfeiting fiber with three material parts and in shape of circular-arc form with same arc-radius, and its slice.

FIGS. 37a and 37b show the anti-counterfeiting fiber with three material parts and in shape of ring form with different arc-radius, and its slice.

FIGS. 38a-1, 38a-2, 38b-1 and 38b-2 respectively show anti-counterfeiting fibers with three material parts and in shape of polygon ring form, and their slices.

FIG. 39 shows a transversal surface along length direction of anti-counterfeiting fiber with S combination of three material parts.

FIG. 39-1 shows a 3-D diagram of an anti-counterfeiting fiber with S combination and in shape of circular ring form.

FIG. 40 shows a transversal surface along length direction of an anti-counterfeiting fiber with T combination of three material parts.

FIG. 40-1 shows a 3-D diagram of an anti-counterfeiting fiber with T combination and in shape of circular ring form.

FIG. 41 shows a transversal surface along length direction of an anti-counterfeiting fiber with U combination of three material parts.

FIG. 42 shows a transversal surface along length direction of an anti-counterfeiting fiber with several S combinations.

FIG. 42-1 shows a 3-D diagram of an anti-counterfeiting fiber with several S combinations and in shape of disc-form.

FIG. 43 shows a transversal surface along length direction of an anti-counterfeiting fiber with several T combinations.

FIG. 43-1 shows a 3-D diagram of an anti-counterfeiting fiber with several T combinations and in shape of disc-form.

FIG. 44 shows a 3-D diagram of an anti-counterfeiting fiber with S combination and in shape of circular ring form, its internal circular ring is a fluorescent double color sector.

FIG. 45 shows a 3-D diagram of an anti-counterfeiting fiber with T combination and in shape of circular ring form, its internal circular ring is a colored double color sector.

FIG. 46 shows a 3-D diagram of an anti-counterfeiting fiber with several S combinations and in shape of disc-form, each internal circular ring is a fluorescent double color sector.

FIG. 47 shows a 3-D diagram of an anti-counterfeiting fiber with several T combinations and in shape of disc-form, each internal circular ring is a colored double color sector.

### EMBODIMENTS

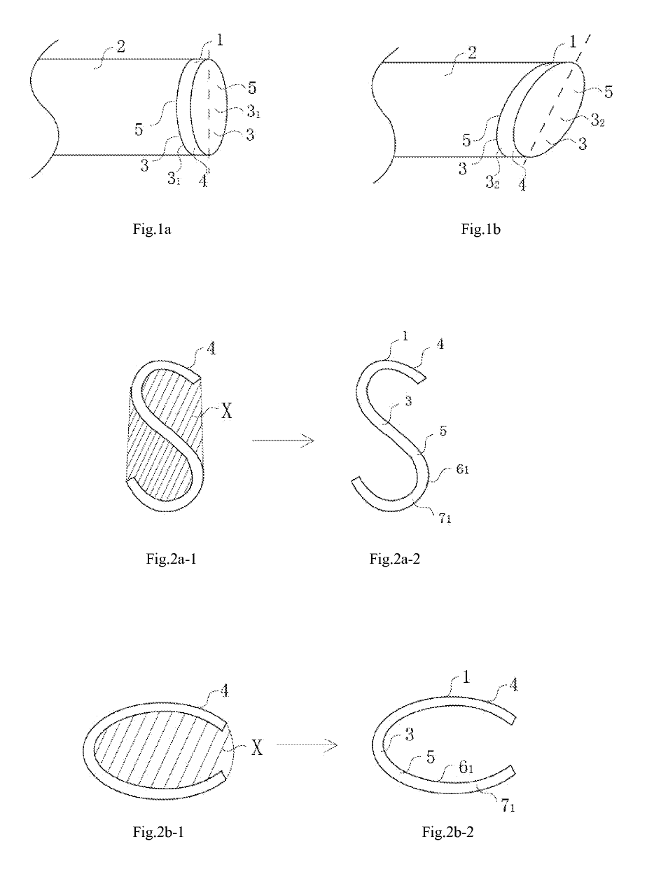

In FIG. 1a, cutting a slice 4 along transversal surface 3₁ of a strip-shaped fiber 2, the slice 4 contains two corresponding cutting surfaces 5, wherein the transversal surface 3₁ refers to the cross-section vertical to longitudinal axis of the strip-shaped fiber 2, the obtained slice 4 is the anti-counterfeiting fiber 1.

In FIG. 1b, cutting a slice 4 along oblique section 32 of a strip-shaped fiber 2, the slice 4 contains two corresponding cutting surfaces 5, wherein the oblique section 32 refers to the cross-section aslant-intersecting to longitudinal axis of the strip-shaped fiber 2, the obtained slice 4 is the anti-counterfeiting fiber 1.

Embodiment 1: Slice 4 or a part of slice 4 is a fine fiber 6₁ (that is, the anti-counterfeiting fiber) with anti-counterfeiting characteristics, height of the fine fiber 6₁ along longitudinal axis direction of strip-shaped fiber 2 is equal to height of the slice 4 or the part of slice 4, that is, the fine fiber 6₁ runs through height direction of the slice 4 or the part of slice 4, the fine fiber 6₁ is a single material part, geometrical shape of the fine fiber 6₁ on surface located with said cutting surface 5 contains following structures:

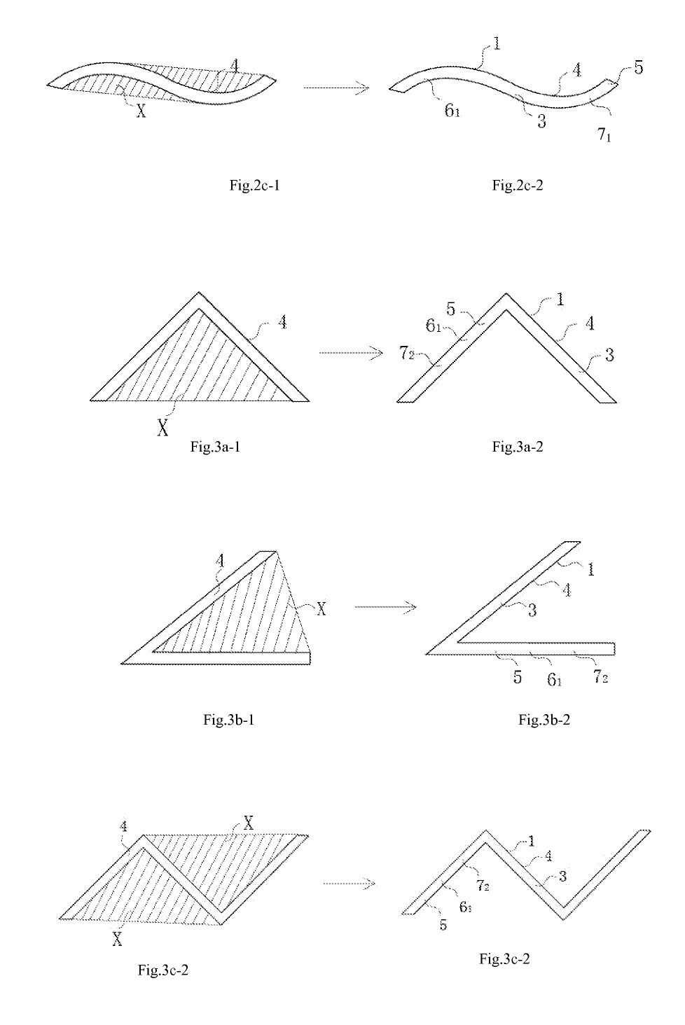

Structure 1: See FIGS. 2a-2, 2b-2 and 2c-2, the fine fiber 6₁ is a non-occluded circular-arc form 7₁ with different arc-radius, the specific structure of said circular-arc form 7₁ can be a residual part of the slice 4 in FIGS. 2a-1, 2b-1 and 2c-1, with their support part X removed, that is, the part of slice 4 is the fine fiber 6₁.

Structure 2: See FIGS. 3a-2, 3b-2 and 3c-2, the fine fiber 6₁ is a non-occluded bended form 7₂, the specific structure of said bended form 7₂ can be a residual part of the slice 4 shown in FIGS. 3a-1, 3b-1 and 3c-1, with their support part X removed, that is, the part of slice 4 is the fine fiber 6₁.

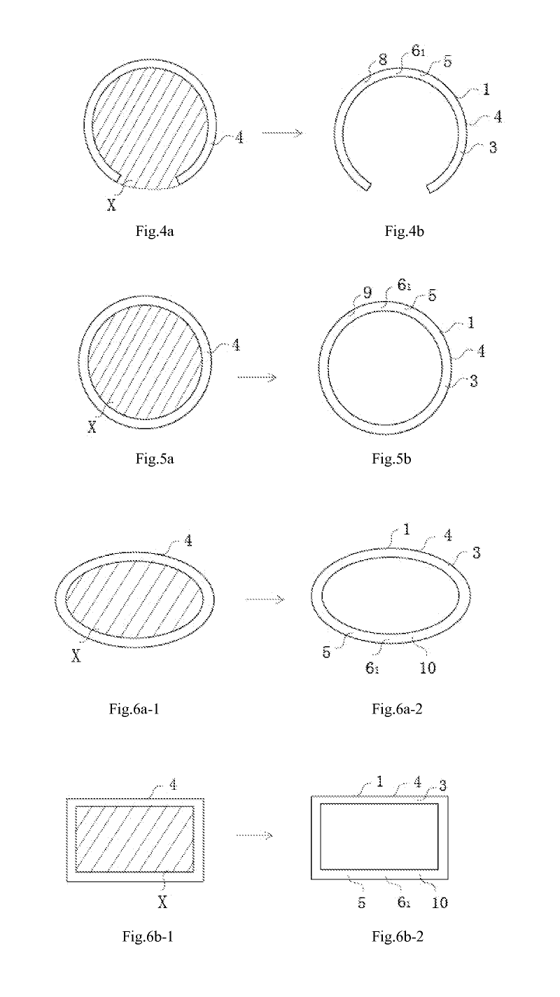

Structure 3: See FIG. 4b, the fine fiber 6₁ is a non-occluded circular-arc form 8 with same arc-radius and radian being over than π but less than 2π, the specific structure of said circular-arc form 8 can be a residual part of the slice 4 shown in FIG. 4a, with its support part X removed, that is, the part of slice 4 is the fine fiber 6₁.

Structure 4: See FIG. 5b, the fine fiber 6₁ of anti-counterfeiting fiber 1 is a circular ring form 9 with same arc-radius, the specific structure of said circular ring form 9 can be a residual part of the slice 4 shown in FIG. 5a, with its support part X removed, that is, the part of slice 4 is the fine fiber 6₁.

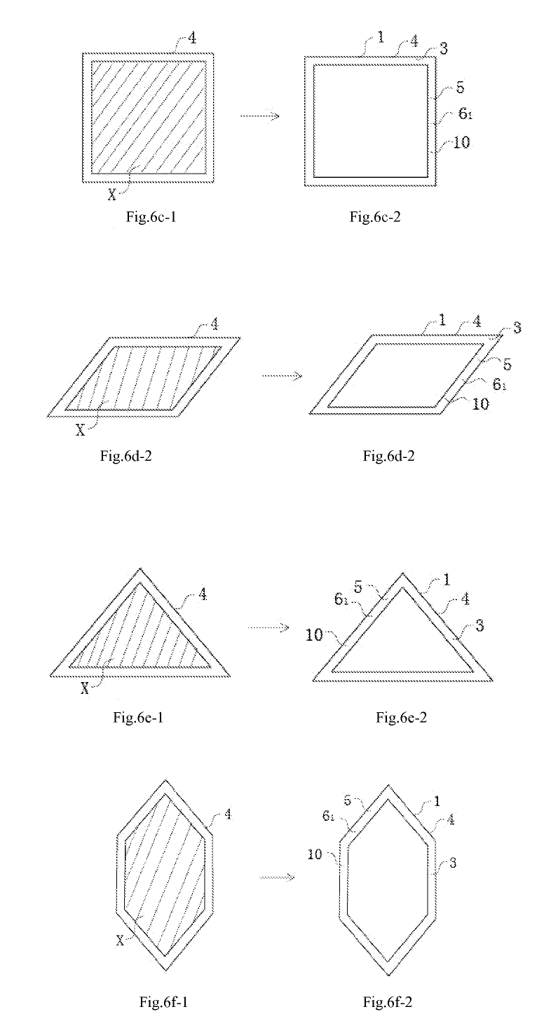

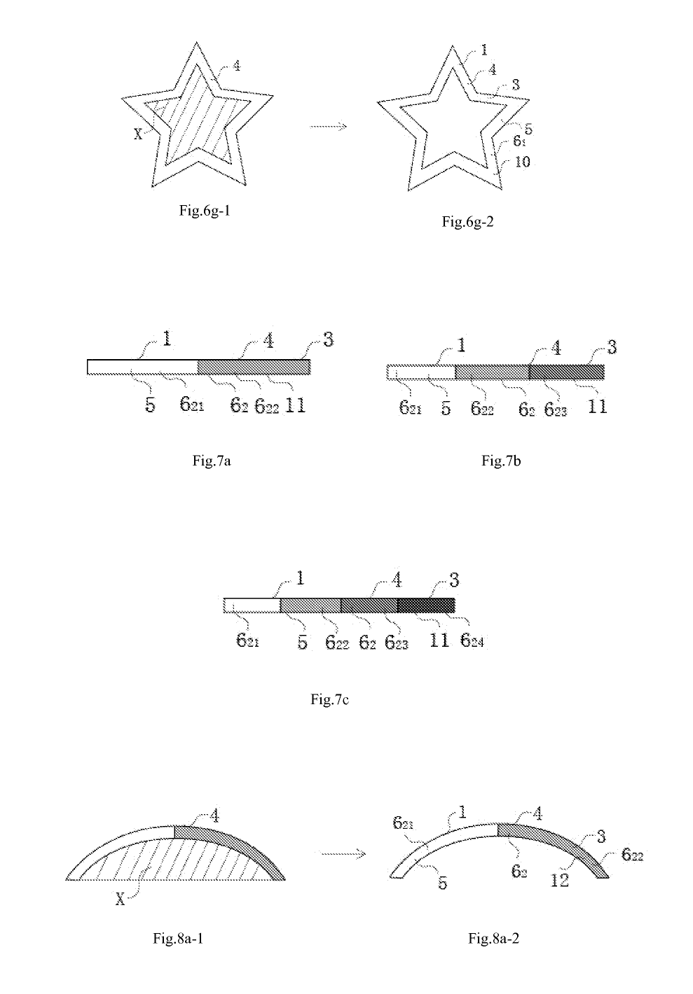

Structure 5: See FIGS. 6a-2, 6b-2, 6c-2, 6d-2, 6e-2, 6f-2 and 6g-2, the fine fiber 6₁ is a oval ring form and polygon ring form 10, wherein the polygon ring form can be in square, rectangle, quadrangle, triangle, hexagon and pentagon. The specific structure of oval ring form or polygon ring form 10 can be a residual part of the slice 4 shown in FIGS. 6a-1, 6b-1, 6c-1, 6d-1, 6e-1, 6f-1 and 6g-1, with their support part X removed, that is, the part of slice 4 is the fine fiber 6₁.

In this embodiment, materials for the fine fiber 6₁ can be transparent material; or colorless fluorescent material; or colored material; or colorless infrared material.

Embodiment 2: Slice 4 or a part of slice 4 is a fine fiber 6₂ (that is, the anti-counterfeiting fiber) with anti-counterfeiting characteristics, height of the fine fiber 6₂ along longitudinal axis direction of strip-shaped fiber 2 is equal to height of the slice 4 or the part of slice 4, that is, the fine fiber 6₂ runs through height direction of the slice 4 or the part of slice 4, any transversal surface of the fine fiber 6₂ is a single material part, but on its length direction of the fine fiber 6₂, there are at least two different material parts distributed, and geometrical shape of the fine fiber 6₂ on surface located with the cutting surface 5 contains following structures:

Structure 1: See FIGS. 7a, 7b and 7c, the fine fiber 6₂ is a straight line form 11, wherein, specific structure of the straight line form as shown in FIG. 7a contains two different material parts 6₂₁ and 6₂₂ distributed along its length direction; specific structure of the straight line form as shown in FIG. 7b contains three different material parts 6₂₁, 6₂₂ and 6₂₃ distributed along its length direction; specific structure of the straight line form as shown in FIG. 7c contains four different material parts 6₂₁, 6₂₂, 6₂₃ and 6₂₄ distributed along its length direction; and the specific structure of the straight line form is the slice 4, that is, the slice 4 is the fine fiber 6₂.

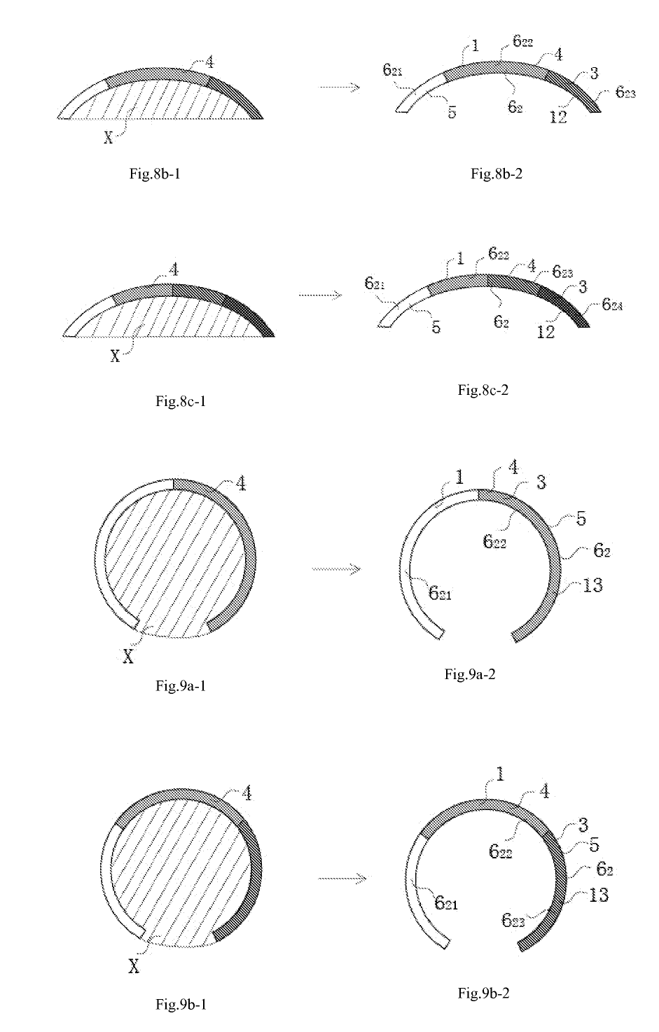

Structure 2: See FIGS. 8a-2, 8b-2 and 8c-2, the fine fiber 6₂ is a circular-arc form 12 with same arc-radius and its radian being equal to or less than π, wherein, for specific structure of the circular-arc form as shown in FIG. 8a-2, there are two different material parts 6₂₁ and 6₂₂ distributed along its length direction; specific structure of the circular-arc form as shown in FIG. 8b-2 contains three different material parts 6₂₁, 6₂₂ and 6₂₃ distributed along its length direction; specific structure of the circular-arc form as shown in FIG. 8c-2 contains four different material parts 6₂₁, 6₂₂, 6₂₃ and 6₂₄ distributed along its length direction; and the special structure of said circular-arc form 12 can be a residual part of slice 4 correspondingly shown in FIGS. 8a-1, 8b-1 and 8c-1, with their support parts X removed, that is, the part of slice 4 is the fine fiber 6₂.

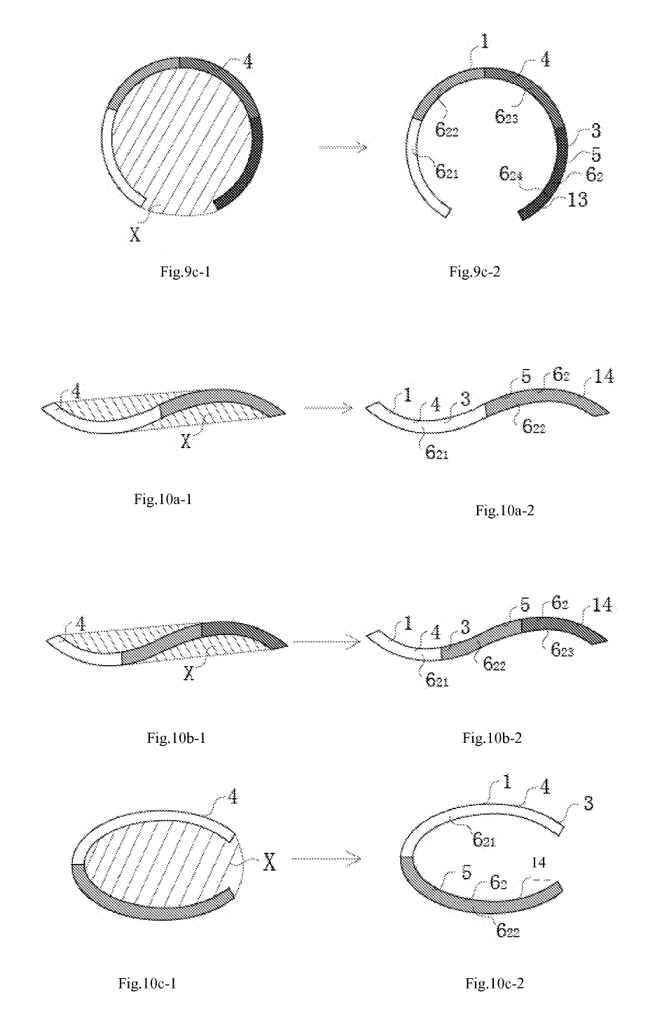

Structure 3: See FIGS. 9a-2, 9b-2, 9c-2 and 9d-2, the fine fiber 6₂ is a circular-arc form 13 with same arc-radius and their radian being over than π but less than 2π, wherein, the specific structure of the circular-arc form as shown in 9a-2 contains two different material parts 6₂₁ and 6₂₂ distributed along its length direction; specific structure of the circular-arc form as shown in FIG. 9b-2 contains three different material parts 6₂₁, 6₂₂ and 6₂₃ distributed along its length direction; specific structure of the circular-arc form as shown in FIG. 9c-2 contains four different material parts 6₂₁, 6₂₂, 6₂₃ and 6₂₄ distributed along its length direction; specific structure of circular-arc form shown in FIG. 9d-2 is the same as that shown in FIG. 9a-2, both of them have two different material parts 6₂₁ and 6₂₂ distributed along length direction, but the circular-arc form shown in FIG. 9a-2 has the same arc-radius while the circular-arc form shown in FIG. 9d-2 has different arc-radius. The specific structure of the circular-arc form 13 can be a residual part of slice 4 correspondingly shown in FIGS. 9a-1, 9b-1, 9c-1 and 9d-1, with their support parts X removed, that is, the part of slice 4 is the fine fiber 6₂.

Structure 4: See FIGS. 10a-2, 10b-2 and 10c-2, the fine fiber 6₂ is a non-occluded circular-arc form 14 with different arc-radius, wherein, the specific structure of the circular-arc form as shown in FIG. 10a-2 contains two different material parts 6₂₁ and 6₂₂ distributed along its length direction; specific structure of the circular-arc form as shown in FIG. 10b-2 contains three different material parts 6₂₁, 6₂₂ and 6₂₃ distributed along its length direction; specific structure of the circular-arc form as shown in FIG. 10c-2 contains two different material parts 6₂₁ and 6₂₂ distributed along its length direction. The specific structure of the circular-arc form 14 can be a residual part of slice 4 correspondingly shown in FIGS. 10a-1, 10b-1 and 10c-1, with their support parts X removed, that is, the part of slice 4 is the fine fiber 6₂.

Structure 5: See FIGS. 11a-2 and 11b-2, the fine fiber 6₂ is a non-occluded bended form 15, wherein, the specific structure of the bended form as shown in FIG. 11a-2 contains two different material parts 6₂₁ and 6₂₂ distributed along its length direction; specific structure of the bended form as shown in FIG. 11b-2 contains three different material parts 6₂₁, 6₂₂ and 6₂₃ distributed along its length direction. The special structure of said bended form 15 can be a residual part of the slice 4 correspondingly shown in FIGS. 11a-1 and 11b-1, with their support parts X removed, that is, the part of slice 4 is the fine fiber 6₂.

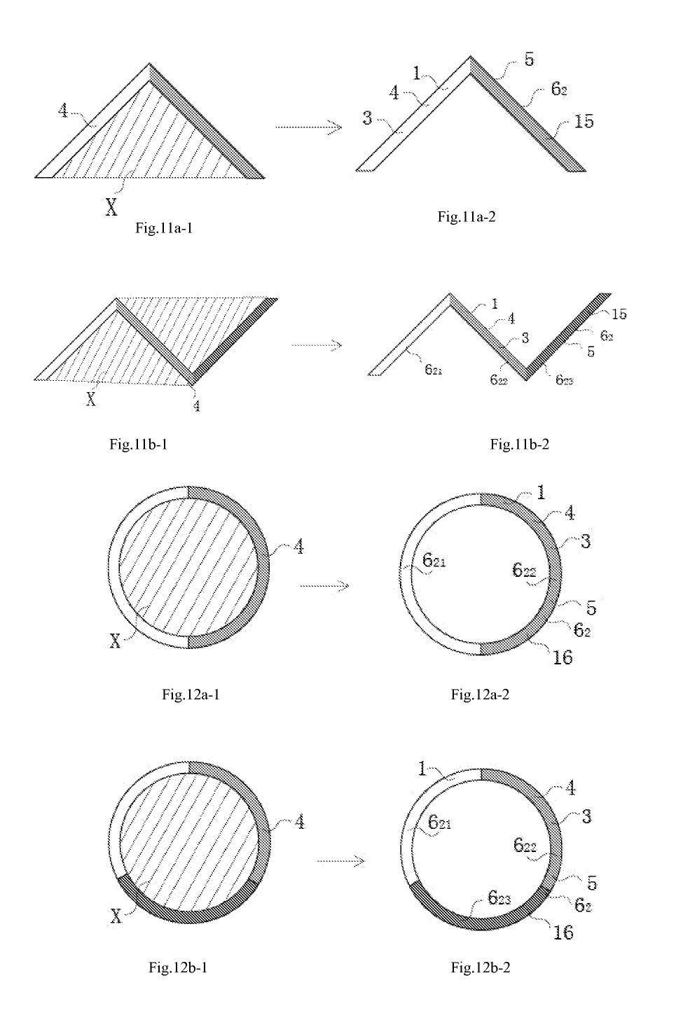

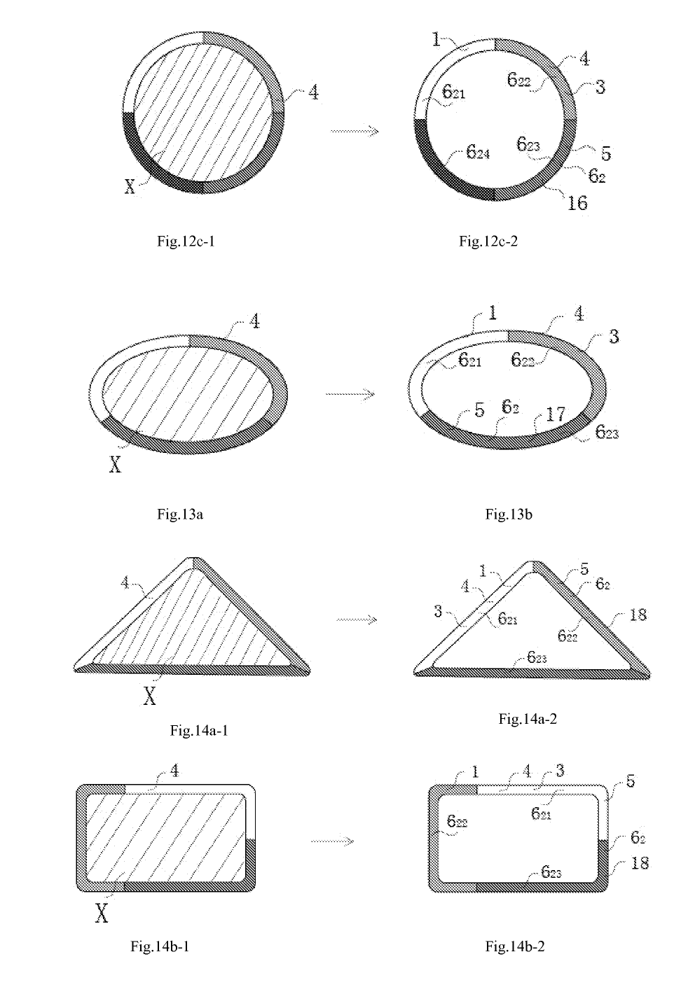

Structure 6: See FIGS. 12a-2, 12b-2 and 12c-2, the fine fiber 6₂ is a circular ring form 16 with the same arc-radius, wherein, the specific structure of the circular ring form as shown in FIG. 12a-2 contains two different material parts 6₂₁ and 6₂₂ distributed along the ring; specific structure of the circular ring form as shown in FIG. 12b-2 contains three different material parts 6₂₁, 6₂₂ and 6₂₃ distributed along the ring; specific structure of the circular ring form as shown in FIG. 12c-2 contains four different material parts 6₂₁, 6₂₂, 6₂₃ and 6₂₄ distributed along the ring. The special structure of the circular ring form 16 can be a residual part of the slice 4 correspondingly shown in FIGS. 12a-1, 12b-1 and 12c-1, with their support parts X removed, that is, the part of slice 4 is the fine fiber 6₂.

Structure 7: See FIG. 13b, the fine fiber 6₂ is a ring form 17 with different arc-radius, wherein, the specific structure of oval ring form as shown in FIG. 13b contains three different material parts 6₂₁, 6₂₂ and 6₂₃ distributed along the oval ring. The specific structure of said oval ring form 17 can be a residual part of oval slice 4 shown in FIG. 13a, with its support part X removed, that is, the part of slice 4 is the fine fiber 6₂.

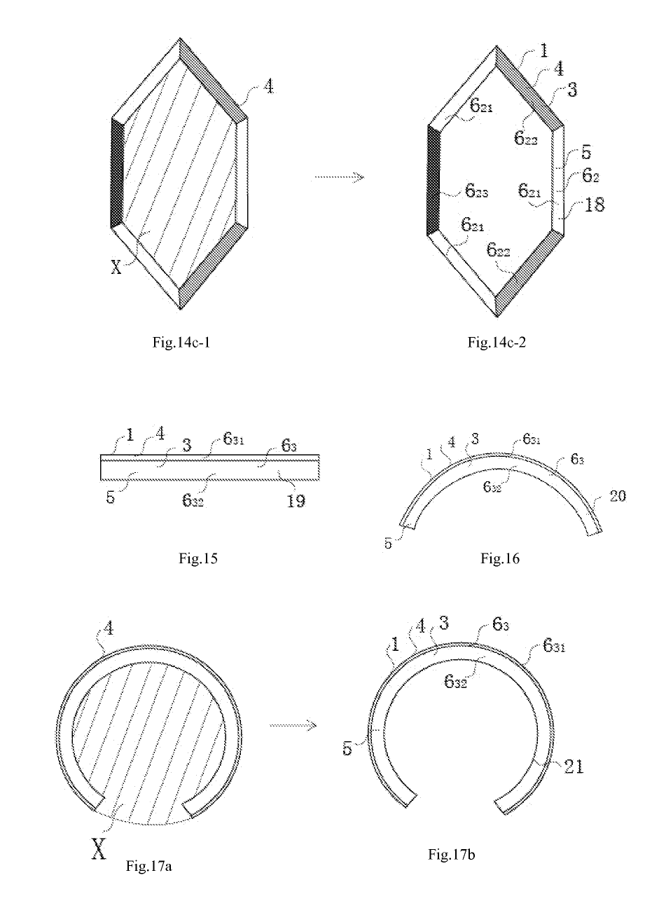

Structure 8: See FIGS. 14a-2, 14b-2 and 14c-2, the fine fiber 6₂ is a polygon ring form 18, wherein, specific structure of the polygon ring form as shown in FIG. 14a-2 is in triangle, there are three different material parts 6₂₁, 6₂₂ and 6₂₃ distributed along its length direction (that is, along the ring); the specific structure of the polygon ring form as shown in 14b-2 is in quadrangle, there are three different material parts 6₂₁, 6₂₂ and 6₂₃ distributed along its length direction (that is, along the ring); the specific structure of the polygon ring form as shown in FIG. 14c-2 is in hexagon, there are three different material parts 6₂₁, 6₂₂ and 6₂₃ distributed along its length direction (that is, along the ring). The specific structure 18 can be a residual part of the slice 4 correspondingly shown in FIGS. 14a-1, 14b-1 and 14c-1, with their support parts X removed, that is, the part of slice 4 is the fine fiber 6₂.

Furthermore, in this Embodiment 2, there are several material parts along the length direction of the fine fiber 6₂, of which at least two material parts are colored materials with different colors able to be directly identified by naked eyes; or in this Embodiment 2, there are several material parts along the length direction of the fine fiber 6₂, of which at least one material part is a colorless transparent material and at least one material part is a colored material; or in the Embodiment 2, there are several material parts along the length direction of the fine fiber 6₂, of which at least two material parts are fluorescent materials with different illuminant colors.

Embodiment 3: Slice 4 or the part of slice 4 is a fine fiber 6₃ (that is, the anti-counterfeiting fiber) with anti-counterfeiting characteristics, height of the fine fiber 6₃ along longitudinal axis direction of strip-shaped fiber 2 is equal to height of the slice 4 or the part of slice 4, that is, the fine fiber 6₃ runs through height direction of the slice 4 or the part of slice 4, the fine fiber 6₃ is composed of two material parts distributed on cutting surface 5 and being parallel with each other and extending along longitudinal axis direction of the strip-shaped fiber 2, that is, first material part 6₃₁ and second material part 6₃₂, there is one or more composition materials distributed along its length direction of any one of the material parts, geometrical shape of the fine fiber 6₃ on surface located with said cutting surface 5 contains following structures:

Structure 1: See FIG. 15, fine fiber 6₃ is a straight line form 19, that is, the slice 4 is the fine fiber 6₃.

Structure 2: See FIG. 16, fine fiber 6₃ is a circular-arc form 20 with same arc-radius and its radian being equal to or less than π, that is, the slice 4 is the fine fiber 6₃.

Structure 3: See FIG. 17b, fine fiber 6₃ is a circular-arc form 21 with same arc-radius and its radian being over than π but less than 2π, the specific structure of said circular-arc form 21 can be a residual part of the slice 4 as shown in FIG. 17a with its support part X removed, that is, the part of slice 4 is the fine fiber 6₃.

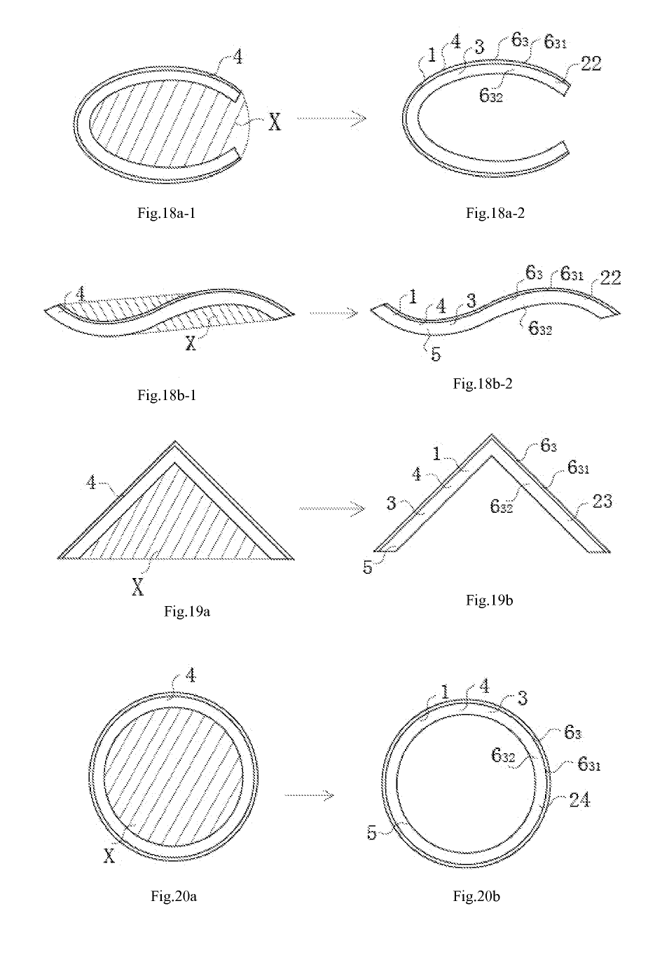

Structure 4: See FIGS. 18a-2 and 18b-2, fine fiber 6₃ is a non-occluded circular-arc form 22 with different arc-radius, the specific structure of said circular-arc form 22 can be a residual part of the slice 4 as shown in FIGS. 18a-1 and 18b-1 with their support parts X removed, that is, the part of slice 4 is the fine fiber 6₃.

Structure 5: See FIG. 19b, fine fiber 6₃ is a non-occluded bended form 23, the specific structure of said bended form 23 can be a residual part of the slice 4 as shown in FIG. 19a with its support part X removed, that is, the part of slice 4 is the fine fiber 6₃.

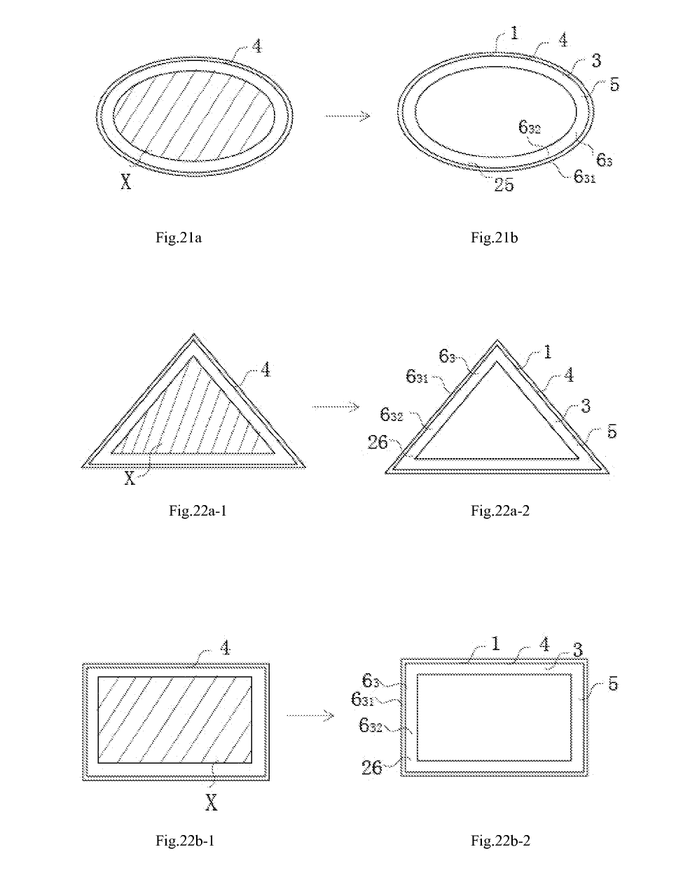

Structure 6: See FIG. 20b, fine fiber 6₃ is a circular ring form 24 with same arc-radius, the specific structure of said circular ring form 24 can be a residual part of the slice 4 as shown in FIG. 20a with its support part X removed, that is, the part of slice 4 is the fine fiber 6₃.

Structure 7: See FIG. 21b, fine fiber 6₃ is a ring form 25 with different arc-radius, the specific structure of said ring form 25 can be a residual part of the slice 4 as shown in FIG. 21a with its support part X removed, that is, the part of slice 4 is the fine fiber 6₃.

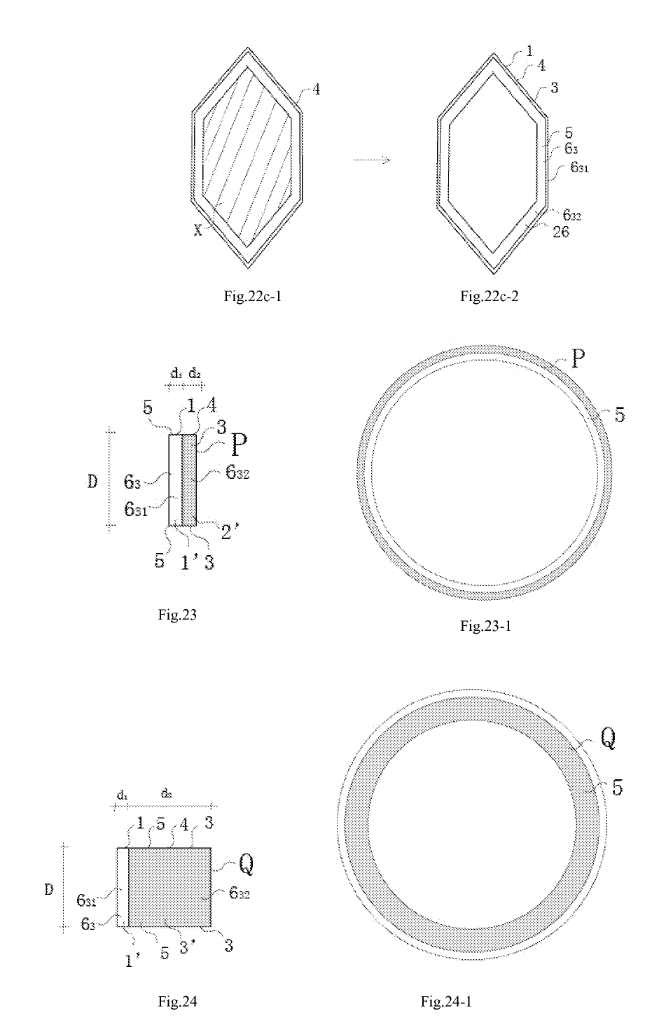

Structure 8: See FIGS. 22a-2, 22b-2 and 22c-2, fine fiber 6₃ is a polygon ring form 26, the specific structure of said polygon ring form 26 can be a residual part of the slice 4 as shown in FIGS. 22a-1, 22b-1 and 22c-1 with their support parts X removed, that is, the part of slice 4 is the fine fiber 6₃.

The following is the Embodiment 3 in more details:

Embodiment 3-1: FIG. 23 shows a transversal surface of the fine fiber 6₃ along its length direction, said first material part 6₃₁ is A fluorescent material 1′ and said second material part 6₃₂ is B fluorescent material 2′, there is obvious visual difference between A fluorescent material 1′ and B fluorescent material 2′ in illuminant colors, said first material part 6₃₁ and the second material part 6₃₂ form P combination; visual characteristic of this P combination is: when exciting light illuminates said P combination structure from different angles, emitting light of the fine fiber 6₃ will form a visual effect of different color changes, this visual effect cannot be simulated by fine line printed with fluorescent ink.

For more detailed design of circular ring form specific structure related to the P combination, FIG. 23-1 shows a plan diagram of the fine fiber 6₃ on cutting surface 5, the sizes of this fine fiber 6₃ are: the diameter of circular ring is 2 mm, the first material part 6₃₁ is an external layer ring containing fluorescent red, thickness d₁=20 μm, height D=50 μm; the second material part 6₃₂ is an internal layer ring containing fluorescent blue, thickness d₂=20 μm, height D=50 μm, said fine fiber 6₃ has unique visual characteristic, when exciting light illuminates said circular ring from any sloping direction, more area of red fluorescent material on half-ring near the exciting light source will be illuminated and red will appear, but more area of blue fluorescent material on half-ring far away from the emitting light source will be illuminated and blue will appear.

Embodiment 3-2: FIG. 24 shows a transversal surface of the fine fiber 6₃ along its length direction, said first material part 6₃₁ is A fluorescent material 1′ and said second material part 6₃₂ is a shelter layer 3′ for exciting light, said first material part 6₃₁ and the second material part 6₃₂ form Q combination; visual characteristic of this Q combination is: when exciting light illuminates said Q combination structure from different angles, emitting light of the fine fiber 6₃ will produce a visual effect of different brightness changes with same color, this visual effect cannot be simulated by fine line printed with fluorescent ink.

For more detailed design of circular ring form specific structure related to the Q combination, FIG. 24-1 shows a plan diagram of the fine fiber 6₃ on cutting surface 5, the sizes of this fine fiber 6₃ are: the diameter of circular ring is 2 mm, the first material part 6₃₁ is an external layer ring containing fluorescent red, thickness d₁=5 μm, height D=50 μm; the second material part 6₃₂ is an internal layer ring containing shelter material for exciting light, thickness d₂=60 μm, height D=50 μm, said special structure has unique visual characteristic, when exciting light illuminates said circular ring from any sloping direction, red fluorescent material on half-ring near the exciting light source will be illuminated and red will appear, but fluorescent red on half-ring far away from the emitting light source will be rarely illuminated because of the exciting light obstructed by the shelter material and dark color will appear.

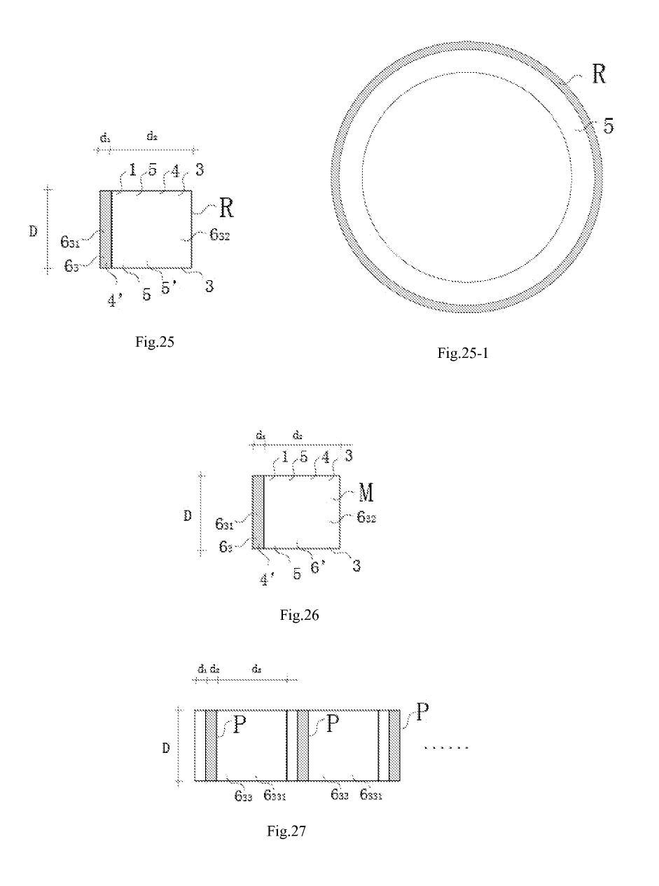

Embodiment 3-3: FIG. 25 shows a transversal surface of the fine fiber 6₃ along its length direction, said first material part 6₃₁ is A colored material 4′ and said second material part 6₃₂ is an white shelter layer 5′ for visible light, said first material part 6₃₁ and the second material part 6₃₂ form R combination; visual characteristic of this R combination is: when observing the R combination structure from different angles by naked eyes, emitting light of the fine fiber 6₃ will produce a visual effect of different brightness changes with same colors, this visual effect cannot be simulated by fine line printed with colored ink.

For more detailed design of circular ring form specific structure related to the R combination, FIG. 25-1 shows a plan diagram of the fine fiber 6₃ on cutting surface 5, the sizes of this fine fiber 6₃ are: the diameter of circular ring is 2 mm, the first material part 6₃₁ is an external layer ring containing eye-visible red color, thickness d₁=3 μm, height D=50 μm; the second material part 6₃₂ is an internal layer ring containing titanium dioxide powder material in white color for sheltering visible light, thickness d₂=60 μm, height D=50 μm; said specific structure has unique visual characteristic, when observing said circular ring from any sloping direction by naked eyes, red on the half-ring near eyes can be seen, so this half-ring appears red color; but for the half-ring far away from naked eyes, this half-ring appears colorless because of the red half-ring, far away from naked eyes, being sheltered by white shelter material.

Embodiment 3-4: FIG. 26 shows a transversal surface of the fine fiber 6₃ along its length direction, said first material part 6₃₁ is A colored material 4′ and said second material part 6₃₂ is a transparent material 6′, said first material part 6₃₁ and the second material part 6₃₂ form M combination; visual characteristic of this fine fiber 6₃ is: the fine fiber 6₃ is a colored line if observing the M combination structure in paper from different angle by naked eye in reflecting light way; but a colored line and a transparent line in parallel can be seen if by transmission light observation, this visual effect cannot be simulated by fine line printed with ink. Followings are further embodiments related to the structure of the Embodiment 3.

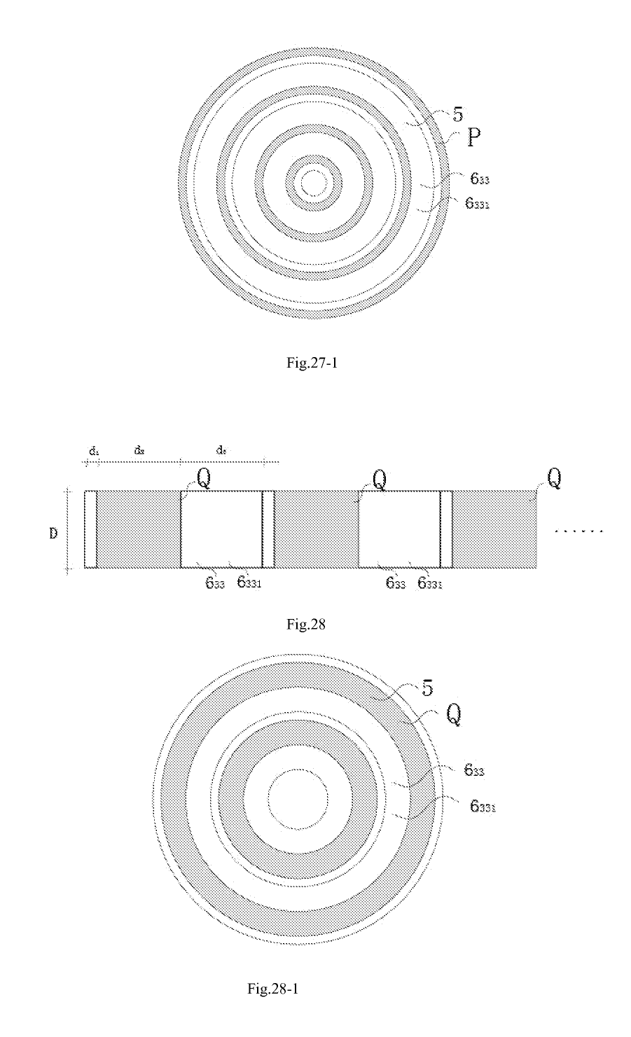

Embodiment 3-5: FIG. 27 shows a transversal surface of the fine fiber 6₃ along its length direction, said fine fiber 6₃ is composed of several material parts distributed on the cutting surface and being parallel with each other and extending along its longitudinal axis direction of said strip-shaped fiber 2, said several material parts contain third material part 6₃₃; said third material part 6₃₃ is a material 6₃₃₁ that does not shelter exciting light, located between any two P combinations adjacent with each other, when exciting light illuminates these several P combination structures in parallel from different angles, the anti-counterfeiting fiber in sheet form will produce exciting light effect of different color change. This visual effect cannot be simulated by printing with fluorescent ink.

For more detailed design of specific structure with disc-form related to several parallel P combinations, FIG. 27-1 shows a plan diagram on cutting surface 5 of several parallel P combination structures, said third material part 6₃₃ is a transparent material 6₃₃₁ that does not shelter exciting light, located between any two P combination rings adjacent with each other, disc diameter is 2 mm, said fine fiber 6₃ has unique visual characteristic, when exciting light illuminates said disc, more area of red fluorescence on half-disc near exciting light source will be illuminated, red half-disc will appear, and more area of blue fluorescence on half-disc far away from exciting light source will be illuminated, blue half-disc will appear.

Embodiment 3-6: FIG. 28 shows a transversal surface of the fine fiber 6₃ along its length direction, the third material part 6₃₃ is a material 6₃₃₁ that does not shelter exciting light, located between any two Q combinations adjacent with each other, two A fluorescent materials 1′ of the two first material parts 6₃₁ of two adjacent Q combinations have the same or different illuminant colors, said fine fiber 6₃ has unique visual characteristic, when exciting light illuminates these several Q combinations in parallel from different angles, emission light of the anti-counterfeiting fiber in sheet form will produce visual effect of varied brightness. This visual effect cannot be simulated by printing with fluorescent ink.

For more detailed design of specific structure with disc-form related to the several parallel Q combinations, FIG. 28-1 shows a plan diagram on cutting surface 5 of the several Q combinations in parallel, said third material part 6₃₃ is a transparent material 6₃₃₁ that does not shelter exciting light, located between any two Q combination rings adjacent with each other; disc diameter is 2 mm, said fine fiber 6₃ has unique visual characteristic, when exciting light illuminates said ring in sloping way, more area of red fluorescence material on half-disc near exciting light source will be illuminated, red half-disc will appear, and red fluorescence material on half-disc far away from exciting light source will be sheltered by material 6₃₃₁, no light or weak red half-disc will appear.

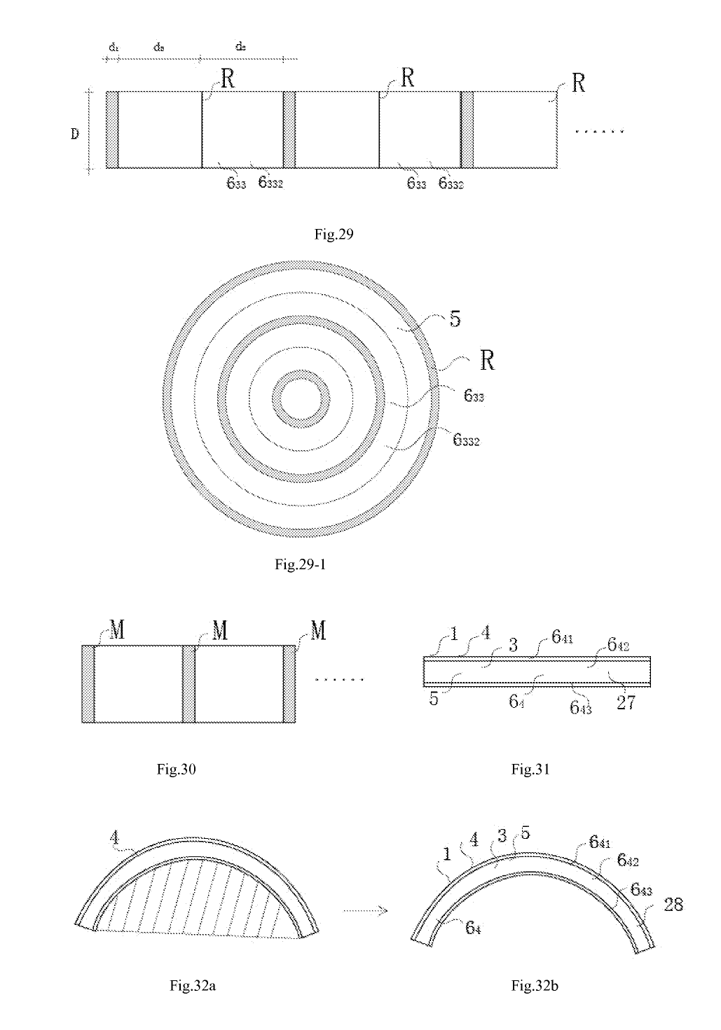

Embodiment 3-7: FIG. 29 shows a transversal surface of the fine fiber 6₃ along its length direction, the third material part is a transparent material 6₃₃₂, located between any two R combinations adjacent with each other, two A colored materials 4′ of the two first material parts 6₃₁ of two adjacent R combinations have the same or different colors able to be directly identified by naked eyes, visual characteristic of this specific structure is: when observing the fine fiber 6₃ by naked eyes from different angles, the fine fiber 6₃ will produce visual effect of varied brightness. This visual effect cannot be simulated by printing with color ink.

For more detailed design of specific structure with disc-form related to the R combinations, FIG. 29-1 shows a plan diagram on cutting surface 5 of the several parallel R combinations, disc diameter is 2 mm, the fine fiber 6₃ has unique visual characteristic, when observing said disc by naked eyes in any sloping direction, red on half-disc near naked eyes is seen, red appears, and the half-disc far away from naked eyes is obstructed by white shelter material, no color or very light red can be seen.

Embodiment 3-8: FIG. 30 shows a transversal surface of the fine fiber 6₃ along its length direction, composed of several M combinations in parallel; two A colored materials 4′ of the two first material parts 6₃₁ have the same or different colors able to be directly identified by naked eyes. When observing the several parallel M combination structures by naked eyes on reflecting light, the fine fibers in sheet form are parallel colored lines in the same or different colors, and if checking via transmission light observation, visual effect can be found is a combination of several colored lines with different colors and transparent lines among colored lines, this visual effect cannot be simulated by printed fine lines with ink.

Embodiment 4: Slice 4 or a part of slice 4 is the fine fiber 6₄ with said anti-counterfeiting characteristics, height of the fine fiber 6₄ along longitudinal axis direction of strip-shaped fiber 2 is equal to height of the slice 4 or the part of slice 4, that is, the fine fiber 6₄ runs through height direction of the slice 4 or the part of slice 4, the fine fiber 6₄ is composed of three material parts distributed on cutting surface and being parallel with each other and extending along longitudinal axis direction of said strip-shaped fiber 2, that is, fourth material part 6₄₁, fifth material part 6₄₂ and the sixth material 6₄₃. Geometrical shape of said fine fiber 6₄ on surface located with said cutting surface 5 contains following structures:

Structure 1: See FIG. 31, fine fiber 6₄ is a straight line form 27, that is, the slice 4 is the fine fiber 6₄.

Structure 2: See FIG. 32b, fine fiber 6₄ is a circular-arc form 28 with the same arc-radius and its radian being equal to or less than π, the specific structure of said circular-arc form 28 can be a residual part of the slice 4 as shown in FIG. 32a with its support part X removed, that is, the part of slice 4 is the fine fiber 6₄.

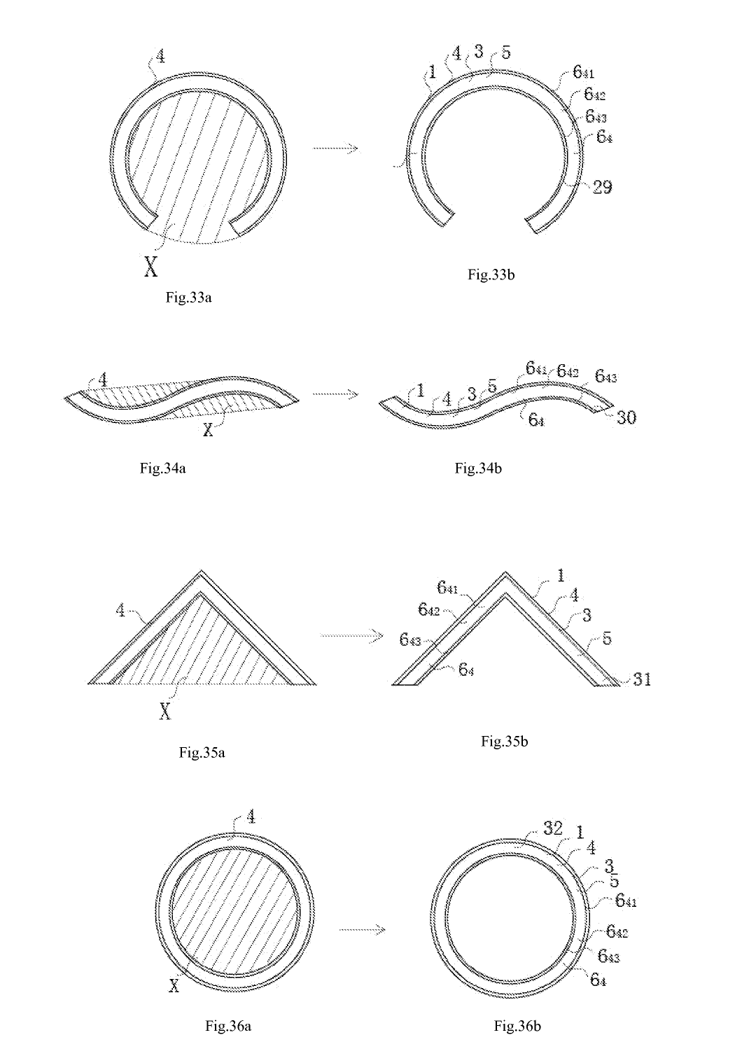

Structure 3: See FIG. 33b, fine fiber 6₄ is a circular-arc form 29 with the same arc-radius and its radian over than π but less than 2π, the specific structure of said circular-arc form 29 can be a residual part of the slice 4 as shown in FIG. 33a with its support part X removed, that is, the part of slice 4 is the fine fiber 6₄.

Structure 4: See FIG. 34b, fine fiber 6₄ is a non-occluded circular-arc form 30 with different arc-radius, the specific structure of said circular-arc form 30 can be a residual part of the slice 4 as shown in FIG. 34a with its support part X removed, that is, the part of slice 4 is the fine fiber 6₄.

Structure 5: See FIG. 35b, fine fiber 6₄ is a non-occluded bended form 31, the specific structure of said bended form 31 can be a residual part of the slice 4 as shown in FIG. 35a with its support part X removed, that is, the part of slice 4 is the fine fiber 6₄.

Structure 6: See FIG. 36b, fine fiber 6₄ is a circular ring form 32 with same arc-radius, the specific structure of said circular ring form 32 can be a residual part of the slice 4 as shown in FIG. 36a with its support part X removed, that is, the part of slice 4 is the fine fiber 6₄.

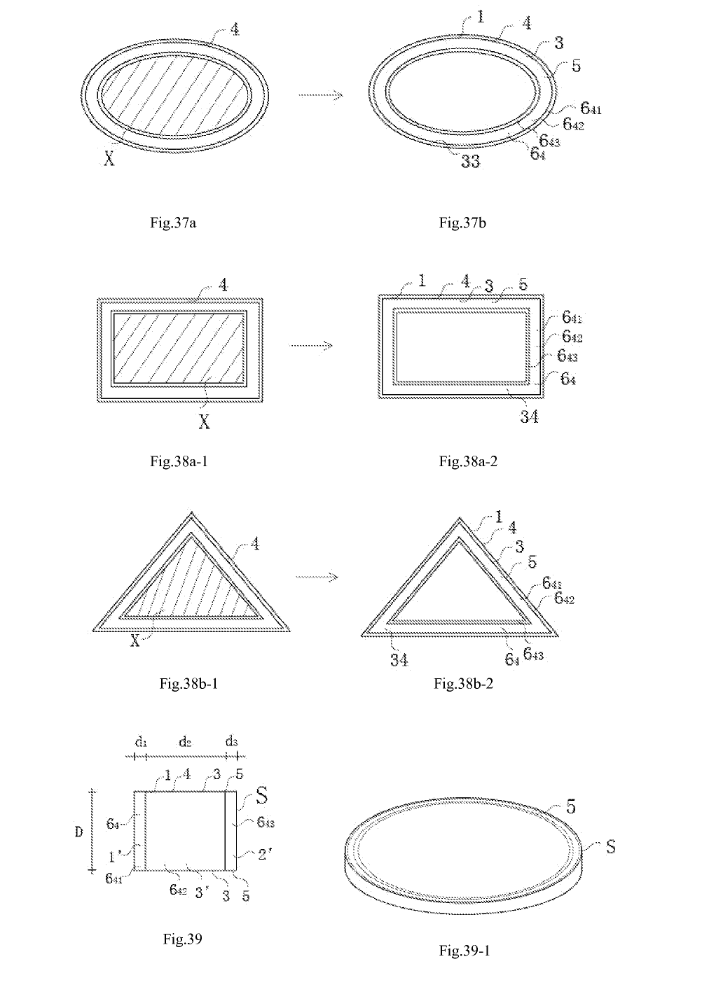

Structure 7: See FIG. 37b, fine fiber 6₄ is a ring form 33 with different arc-radius, the specific structure of said ring form 33 can be a residual part of the slice 4 as shown in FIG. 37a with its support part X removed, that is, the part of slice 4 is the fine fiber 6₄.

Structure 8: See FIGS. 38a-2 and 38b-2, fine fiber 6₄ is a polygon ring form 34, the specific structure of said polygon ring form 34 can be a residual part of the slice 4 as shown in FIGS. 38a-1 and 38b-1 with their support part X removed, that is, the part of slice 4 is the fine fiber 6₄.

The following is more details for Embodiment 4:

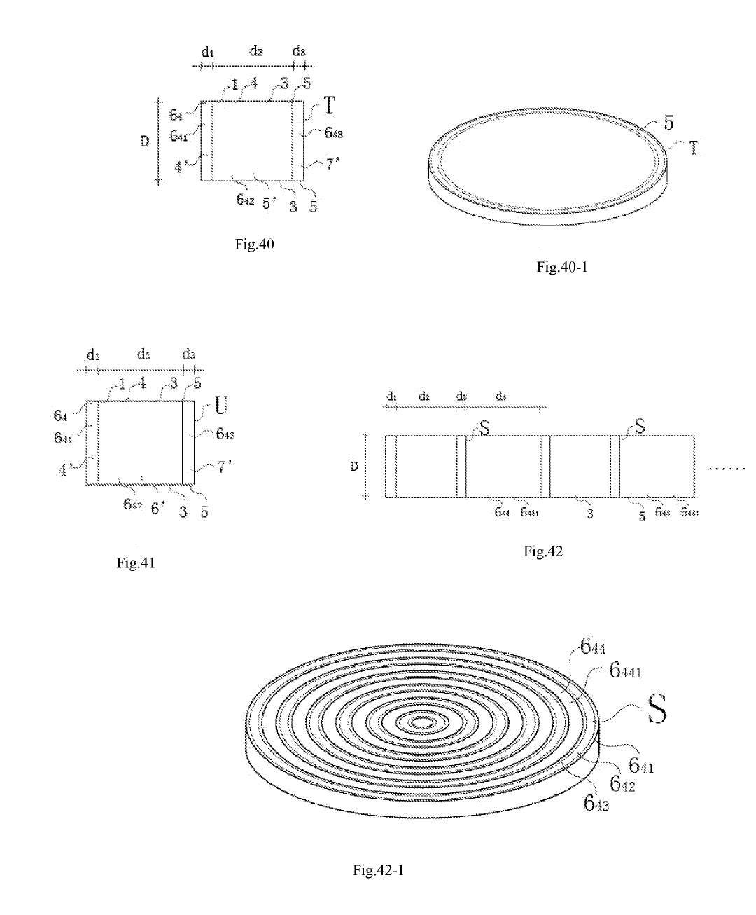

Embodiment 4-1: FIG. 39 shows a transversal surface of the fine fiber 6₄ along its length direction, fourth material part 6₄₁ is A fluorescent material 1′, fifth material part 6₄₂ is a shelter layer 3′ for exciting light, said sixth material part 6₄₃ is B fluorescent material 2′, wherein, there is obvious visual difference between A fluorescent material 1′ and B fluorescent material 2′ in illuminant color, the fifth material part 6₄₂ is located between the fourth material part 6₄₁ and the sixth material part 6₄₃, the fourth material part 6₄₁, the fifth material part 6₄₂ and the sixth material part 6₄₃ form S combination; when exciting light illuminates the S combination structure from different angles, its emission light will produce a visual effect of different color changes, this visual effect cannot be simulated by fine line printed with fluorescent ink. Shelter layer 3′ for exciting light of the fifth material part 6₅ plays as a middle interval layer with a function of further preventing the exciting light from optical crosstalk, in order to ensure more obvious effect of fluorescent color changes.

For more detailed design of circular ring form specific structure related to the S combination, FIG. 39-1 shows a 3-D diagram of anti-counterfeiting fiber 6₄ with S combination, the diameter of circular ring is 2 mm, the fourth material part 6₄₁ is an external layer circular ring containing fluorescent red, thickness d₁=5 μm, height D=50 μm; the sixth material part 6₄₃ is an internal layer circular ring containing fluorescent blue, thickness d₃=5 μm, height D=50 μm, the fifth material part 6₄₂ is a shelter layer 3′ for exciting light, thickness d₂=60 μm, height D=50 μm; the anti-counterfeiting fiber 6₄ with S combination has unique visual characteristic, when exciting light illuminates said circular ring from any sloping direction, more area of red fluorescent material on half-ring near the exciting light source will be illuminated and red will appear, but more area of blue fluorescent material on half-ring far away from the exciting light source will be illuminated and blue will appear. Comparing with Embodiment 3-2, because there is a shelter layer for exciting light, these two fluorescent layers can be thinner, and the shelter layer can more effectively prevent the exciting light from optical crosstalk, therefore, color change of the emission light is more obvious when changing the angle of the exciting light.

Embodiment 4-2: FIG. 40 shows a transversal surface of the fine fiber 6₄ along its length direction, fourth material part 6₄₁ is A colored material 4′, fifth material part 6₄₂ is a white shelter layer 5′ for visible light, and sixth material part 6₄₃ is B colored material 7′, wherein there is obvious difference between A colored material 4′ and B colored material 7′ in colors which can be directly identified by naked eyes, the fifth material part 6₄₂ is located between the fourth material part 6₄₁ and the sixth material part 6₄₃, the fourth material part 6₄₁, the fifth material part 6₄₂ and the sixth material part 6₄₃ form T combination; when observing the T combination structure by naked eyes from different angles, the fine fiber 6₄ will produce a visual effect of different color changes, this visual effect cannot be simulated by fine line printed with color ink.

For more detailed design of circular ring form specific structure related to the T combination, FIG. 40-1 shows a 3-D diagram of anti-counterfeiting fiber 6₄ with T combination, the diameter of circular ring is 2 mm, the fourth material part 6₄₁ is an external layer circular ring containing A colored material 4′, thickness d₁=5 nm, height D=50 μm; the sixth material part 6₄₃ is an internal layer circular ring containing B colored material 7′, thickness d₃=5 μm, height D=50 μm, the fifth material part 6₄₂ is a white shelter layer 5′ for visible light, thickness d₂=60 μm, height D=50 μm; said fine fiber 6₄ has unique visual characteristic, when observing said circular ring by naked eyes from any sloping direction, red on half-ring near naked eyes appears more, red appears, but blue on half-ring far away from naked eyes appears more, blue appears.

Embodiment 4-3: FIG. 41 shows a transversal surface of the fine fiber 6₄ along its length direction, fourth material part 6₄₁ is A colored material 4′, fifth material part 6₄₂ is a transparent material 6′ and sixth material part 6₄₃ is B colored material 7′, wherein, A colored material 4′ and B colored material 7′ has obvious difference in color, which can be directly identified by naked eyes, the fifth material part 6₄₂ is located between the fourth material part 6₄₁ and the sixth material part 6₄₃, the fourth material part 6₄₁, the fifth material part 6₄₂ and the sixth material part 6₄₃ form U combination; when observing the U combination structure via naked eyes by reflecting light, two parallel lines in different colors can be seen; and if by transmission light, the visual effect can be seen, that is, a combination of two colored lines in different colors and a transparent line between colored lines. This visual effect cannot be simulated by fine line printed with ink.

Embodiment 4-4: FIG. 42 shows a transversal surface of the fine fiber 6₄ along its length direction, there are several S combinations in parallel on the transversal surface and there also is a seventh material part 6₄₄ as a transparent material 6′ inserted into two adjacent S combinations. When exciting light illuminates several parallel S combination structures in paper from different angles, emission light of the fine fiber 6₄ will produce a visual effect of different color changes. This visual effect cannot be simulated by fine line printed with fluorescent ink. Shelter layer 3′ for exciting light of the fifth material part 6₄₂ plays as a middle interval layer as a function of further preventing the exciting light from optical crosstalk, in order to ensure more obvious effect of fluorescent color changes.

For more detailed design of disc-form specific structure related to several S combinations in parallel, FIG. 42-1 shows a 3-D diagram of anti-counterfeiting fiber 6₄ with several S combinations, slice 4 includes several circular ring form S combinations and there is a seventh material part 6₄₄ as a transparent material 6₄₄₁ that does not obstruct exciting light located between two adjacent S combinations, disc diameter is 2 mm, said specific structure has unique visual characteristic, when exciting light illuminates said disc in a sloping way, more area of red fluorescence on half-disc near exciting light source is illuminated, red half-disc appears, but more area of blue fluorescence on half-disc far away from exciting light source is illuminated, blue half-disc appears.

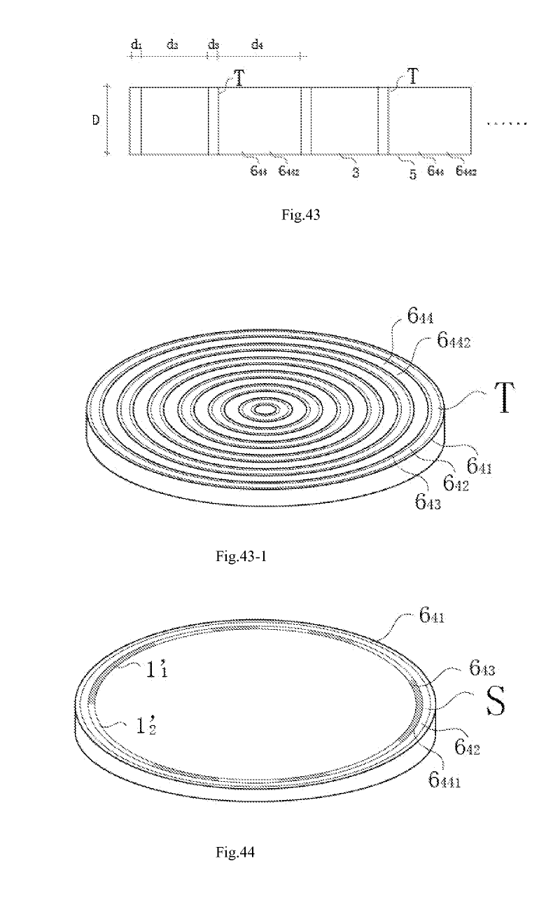

Embodiment 4-5: FIG. 43 shows a transversal surface of the fine fiber 6₄ along its length direction, there are several T combinations in parallel on the transversal surface and there also is a seventh material part 6₄₄ as a transparent material 6₄₄₂ inserted between two adjacent and parallel T combinations. When observing these several parallel T combinations by naked eyes from different angles, the fine fiber 6₄ will produce a visual effect of different color changes, this visual effect cannot be simulated by fine line printed with color ink.

For more detailed design of disc-form specific structure related to several T combinations in parallel, FIG. 43-1 shows a 3-D diagram of anti-counterfeiting fiber 6₄ with several T combinations, the anti-counterfeiting fiber 6₄ includes several circular ring form T combinations and there is a seventh material part 6₄₄ as a transparent material 6₄₄₂ inserted between two adjacent T combinations, disc diameter is 2 mm, the anti-counterfeiting fiber 6₄ has unique visual characteristic, when observing the disc by naked eyes from any sloping direction, more area of red on half-disc near naked eyes can be seen, red half-disc appears, but more area of blue on half-disc far away from naked eyes can be seen, blue half-disc appears.

For further preference, in the above Embodiment 3 series (Embodiments 3, 3-1, 3-2, 3-3, 3-4, 3-5, 3-6, 3-7 and 3-8), and Embodiment 4 series (Embodiments 4, 4-1, 4-2, 4-3, 4-4 and 4-5), any one of said colored material parts or/and any one of said fluorescent material parts has several material sectors distributed along its own length direction, wherein, there are at least two of said material sectors having colored materials in different colors directly discernible by naked eyes; or there is at least one material sector of colorless transparent material and at least one material sector of colored material; or there are at least two material sectors having fluorescent materials with different illuminant colors. Following embodiments make further explanations.

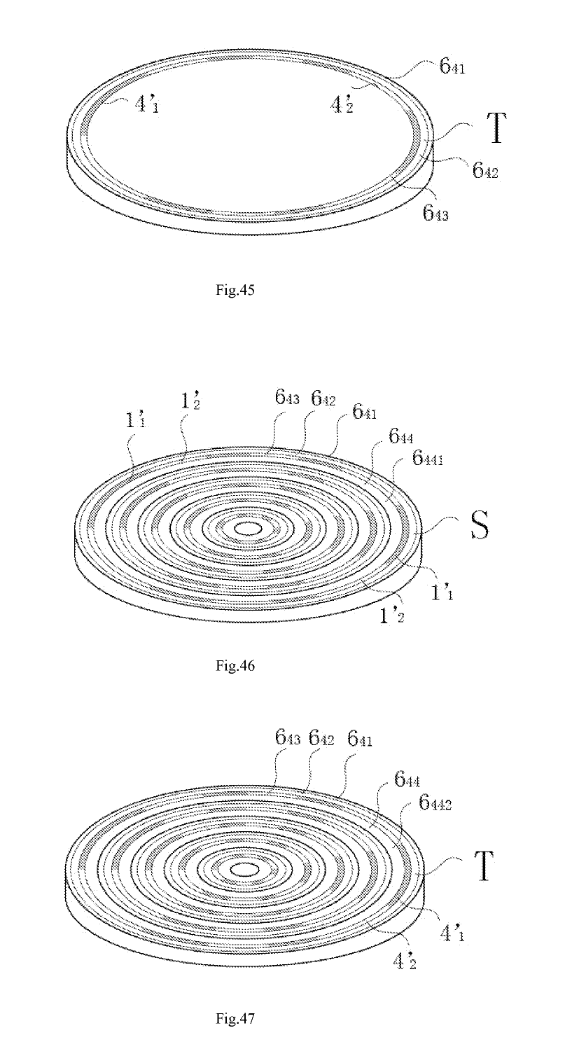

Embodiment 5: A specific design of circular ring form fine fiber 6₄ (that is, an anti-counterfeiting fiber) with a S combination, the fine fiber 6₄ is a part of slice, FIG. 44 shows a 3-D diagram of said specific structure, the diameter of circular ring is 2 mm, fourth material part 6₄₁ is an external-layer circular ring containing fluorescent red, thickness d₁=5 μm, height D=50 μm; sixth material part 6₄₃ is an internal-layer circular ring containing fluorescent material, there are two fluorescent material sectors 1₁′ and 1₂′ in different illuminant colors, respectively fluorescent blue and fluorescent yellow, located at intervals along the internal circular ring direction, thickness d₃=5 μm, height D=50 m; fifth material part 6₄₂ is a shelter layer for exciting light, thickness d₂=60 μm, height D=50 μm; the anti-counterfeiting fiber 6₄ has unique visual characteristic, when exciting light illuminating said circular ring from any sloping direction, more area of red fluorescent on the half-ring near the exciting light source is illuminated, red appears, more area of double color sector of fluorescent blue/yellow on the half-ring far away from exciting light source is illuminated, double color sector of fluorescent blue/yellow appears.

Embodiment 6: A specific design of circular ring form fine fiber 6₄ with a T combination, the fine fiber 6₄ is a part of slice, FIG. 45 shows a 3-D diagram of said specific structure, the diameter of circular ring is 2 mm, fourth material part 6₄₁ is an external-layer circular ring containing A colored material in red color, thickness d₁=5 μm, height D=50 μm; sixth material part 6₄₃ is an internal-layer circular ring of colored material, there are two material sectors 4₁′ and 4₂′ with different colors, respectively in blue color and yellow color, located at intervals along the internal circular ring direction, thickness d₃=5 μm, height D=50 μm; fifth material part 6₄₂ is a white shelter layer 5′ for visible light, thickness d₂=60 μm, height D=50 μm; the anti-counterfeiting fiber 6₄ has unique visual characteristic, when observing said circular ring by naked eyes from any sloping direction, more red on the half-ring near naked eyes appears, red appears, more double color sector of blue/yellow on the half-ring far away from naked eyes appears, double color sector of blue/yellow appears.

Embodiment 7: A specific design of disc-form fine fiber 6₄ with several parallel S combinations, the fine fiber 6₄ is a whole slice, FIG. 46 shows a 3-D diagram of said specific structure, slice 4 contains several circular ring form S combinations, and there is a circular ring form seventh material part 6₄₄ of transparent material 6₄₄₁ that does not obstruct exciting light, located between two adjacent circular ring form S combinations, disc diameter is 2 mm, fourth material part 6₄₁ is an external-layer circular ring containing fluorescent red, thickness d₁=5 μm, height D=50 μm; sixth material part 6₄₃ is an internal-layer circular ring containing fluorescent material, there are two fluorescent material sectors 1₁ ‘and 1₂’ in different illuminant colors, respectively fluorescent blue and fluorescent yellow, located at intervals along the internal circular ring direction, thickness d₃=5 μm, height D=50 μm; fifth material part 6₄₂ is a shelter layer for exciting light, d₂=60 μm, height D=50 μm; the anti-counterfeiting fiber 6₄ has unique visual characteristic, when the exciting light source illuminates said disc from any sloping direction, more area of red fluorescence on the half-disc near the exciting light source is illuminated, red half-disc appears; more area of half-disc far away from exciting light source and composed of fan-shaped fluorescent blue and fan-shaped fluorescent yellow is illuminated, the half-disc composed of fan-shaped fluorescent blue and fan-shaped fluorescent yellow appears.

Embodiment 8: A specific design of disc-form anti-counterfeiting fiber 6₄ related with several parallel T combinations, the anti-counterfeiting fiber 6₄ is a whole slice, FIG. 47 shows a 3-D diagram of said specific structure, slice 4 contains several circular ring form T combinations, and there is a seventh material section 6₄₄ of transparent material 6₄₄₂ located between two adjacent T combinations, disc diameter is 2 mm, said anti-counterfeiting fiber 6₄ has unique visual characteristic, when observing said disc by naked eyes from any sloping direction, more area of red on the half-disc near naked eyes is seen, red half-disc appears; more area of half-disc far away from naked eyes and composed of fan-shaped blue and fan-shaped yellow is seen, a half-disc composed of fan-shaped blue and fan-shaped yellow appears.

In embodiments from 3 to 8, for the parts of said fine fibers 6₃, 6₄ containing A fluorescent material 1′, B fluorescent material 2′, A colored material 4′ and B colored material 7′, distance D (height D along longitudinal axis direction of the strip-shaped fiber 2) between two cutting surfaces corresponding to said part is over than the part's width d appeared on its cutting surface; or D/d>2, see FIGS. 23, 24, 25, 27, 28, 29, 39, 40, 42 and 43. One of the typical sizes is D=50 μm, d≦5 μm. Such design is for further enhancing notability of color change of fluorescent optical angle and color change of colored optical angle.

Embodiment 9: An anti-counterfeiting paper, in said anti-counterfeiting paper there is one of said anti-counterfeiting fibers mentioned in all embodiments described above.

Embodiment 10: A manufacture method of said anti-counterfeiting fiber mentioned above includes following processes:
A. preparing a strip-shaped fiber 2, said strip-shaped fiber 2 comprises a specific structure along its length direction providing the anti-counterfeiting characteristics to said slice 4;
B. cutting the strip-shaped fiber 2 along transversal surface 3₁ or oblique section 3₂ of the strip-shaped fiber 2 into slice 4 in sheet, said slice 4 has said anti-counterfeiting characteristics, said slice 4 is the anti-counterfeiting fiber.

Embodiment 11: A manufacture method of the above anti-counterfeiting fiber includes following processes:
A. preparing a strip-shaped fiber 2, said strip-shaped fiber 2 comprises a specific structure along its length direction providing the anti-counterfeiting characteristics to said part of slice 4;
B. cutting the strip-shaped fiber 2 along transversal surface 3₁ or oblique section 3₂ of the strip-shaped fiber 2 into slices 4 in sheet;
C. removing support part of said slice 4, the residual part of slice 4 has said anti-counterfeiting characteristics, said part of slice 4 is the anti-counterfeiting fiber.

Embodiment 12: A manufacture method of the above anti-counterfeiting paper includes following processes:

A preparing a strip-shaped fiber 2, said strip-shaped fiber 2 comprises a specific structure along its length direction providing the anti-counterfeiting characteristics to said slice 4;
B. cutting the strip-shaped fiber 2 along transversal surface 3₁ or oblique section 3₂ of the strip-shaped fiber 2 into slice 4 in sheet, said slice 4 has said anti-counterfeiting characteristics, said slice 4 is an anti-counterfeiting fiber;
C. adding the slice 4 into paper to manufacture the anti-counterfeiting paper;
at least one of cutting surfaces of said slice 4 is parallel to surface of said anti-counterfeiting paper.

Embodiment 13: A manufacture method of the above anti-counterfeiting paper includes following processes:

A. preparing a strip-shaped fiber 2, said strip-shaped fiber 2 comprises a specific structure along its length direction providing the anti-counterfeiting characteristics to said part of slice 4;
B. cutting the strip-shaped fiber 2 along transversal surface 3₁ or oblique section 3₂ of the strip-shaped fiber 2 into slice 4 in sheet;
C. removing support part of said slice 4, the residual part of slice 4 has said anti-counterfeiting characteristics, said part of slice 4 is an anti-counterfeiting fiber;
D. adding the part of slice 4 into paper to manufacture the anti-counterfeiting paper;
furthermore, at least one of cutting surfaces of said part of slice 4 is parallel to surface of said anti-counterfeiting paper.

For further preference, in embodiments 10 to 13 mentioned above, said strip-shaped fiber 2 is prepared via spinning process by water cooling.

1. An anti-counterfeiting fiber comprising:
a slice or a part of slice formed by cutting a strip-shaped fiber along a cross-section thereof, wherein:
said cross-section defines a transversal surface or oblique section;
said strip-shaped fiber comprises a specific structure along a length direction thereof, providing the anti-counterfeiting characteristics to said slice or the part of slice, said slice or the part of slice having said anti-counterfeiting characteristics;
said transversal surface refers to the cross-section perpendicular to the longitudinal axis of the strip-shaped fiber;
said oblique section refers to the cross-section aslant-intersecting to the longitudinal axis of the strip-shaped fiber and
said part of slice refers to a residual part after removing a support part from the slice.

2. (canceled)

3. (canceled)

4. An anti-counterfeiting fiber as in claim 1, wherein said slice has two cutting surfaces that are parallel with each other.

5. An anti-counterfeiting fiber as in claim 4, wherein, when said anti-counterfeiting fiber is mixed into paper, at least one of the cutting surfaces of said slice being parallel to a surface of said paper.

6. An anti-counterfeiting fiber as in claim 1, wherein said specific structure refers to at least two material parts distributed on the cross-section of the strip-shaped fiber.

7. (canceled)

8. (canceled)

9. An anti-counterfeiting fiber as in claim 1, wherein said slice or said part of slice contains at least one fine fiber with said anti-counterfeiting characteristics, the height of said fine fiber along the longitudinal axis direction of the strip-shaped fiber being equal to a height of the slice or the part of slice, any transversal surface of said fine fiber being a single material part, at least two material parts being distributed along a length direction of said fine fiber, wherein a geometrical shape of said fine fiber on a surface located with a cutting surface contains at least one of the following structures:
structure 1: straight line form; or
structure 2: circular-arc form having a substantially uniform arc radius that subtends an angle equal to or less than π radians; or
structure 3: circular-arc form having a substantially uniform arc radius that subtends an angle more than π radians and less than 2π radians; or
structure 4: non-occluded circular-arc form having an arc radius that varies along the length thereof; or
structure 5: non-occluded bended form; or
structure 6: circular ring form with a substantially uniform arc radius; or
structure 7: ring form having an arc radius that varies along the length thereof; or
structure 8: polygon ring form.

10. An anti-counterfeiting fiber as in claim 9, wherein:
there are at least two material parts distributed along the length direction of said fine fiber, in which said at least two material parts are colored materials with different colors that can be identified directly by naked eyes; or
along the length direction of said fine fiber at least two material parts are distributed, of which at least one is a colorless transparent material and at least another is a colored material; or
along the length direction of said fine fiber at least two material parts are distributed, of which at least two are fluorescent materials with different illuminant colors.

11. An anti-counterfeiting fiber as in claim 1, wherein said slice or said part of slice contains at least one fine fiber with said anti-counterfeiting characteristics, the height of said fine fiber along the longitudinal axis direction of the strip-shaped fiber being equal to a height of the slice or the part of slice, said fine fiber being formed from two material parts being distributed on at least one of the two cutting surfaces, and being parallel with each other and extending along the longitudinal axis direction of said strip-shaped fiber, said two material parts including a first material part and a second material part, wherein there are one or more composition materials distributed along a length direction of either one of said material parts, wherein a geometrical shape of said fine fiber on a surface located with a cutting surface contains at least one of the following structures:
structure 1: straight line form; or
structure 2: circular-arc form having a substantially uniform arc radius that subtends an angle equal to or less than π radians; or
structure 3: circular-arc form having a substantially uniform arc radius that subtends an angle more than π radians and less than 2π radians; or
structure 4: non-occluded circular-arc form having an arc radius that varies along the length thereof; or
structure 5: non-occluded bended form; or
structure 6: circular ring form with a substantially uniform arc radius; or
structure 7: ring form having an arc radius that varies along the length thereof; or
structure 8: polygon ring form.

12. An anti-counterfeiting fiber as in claim 11, wherein there are several material sectors distributed along the length direction of any one of said material parts, wherein:
at least two of the several material sectors are colored materials with different colors directly discernible by naked eyes, or
at least one of the several material sectors is a colorless transparent material and at least another of the several material sectors is a colored material, or
at least two of the several material sectors are fluorescent materials with different illuminant colors.

13. An anti-counterfeiting fiber as in claim, wherein:
said first material part contains A fluorescent material and said second material part contains B fluorescent material, the A fluorescent material and the B fluorescent material having an obvious visual difference in illuminant colors, said first material part and the second material part forming P combination, or
said first material part contains A fluorescent material and said second material part is a shelter layer for exciting light, said first material part and the second material part forming Q combination, or
said first material part contains A colored material and said second material part is a white shelter layer for visible light, said first material part and the second material part forming R combination, or
said first material part contains A colored material and said second material part is a transparent material, said first material part and the second material part forming M combination.

14. An anti-counterfeiting fiber as in claim 13, wherein:
said fine fiber is formed from several material parts distributed on cutting surfaces, and being parallel with each other and extending along the longitudinal axis direction of the strip-shaped fiber, said several material parts including a third material part and:
several P combinations, said third material part is being a material not obstructing exciting light, which is located between any two adjacent P combinations, or
several Q combinations, said third material part being a material not obstructing exciting light, which is located between any two adjacent Q combinations, two A fluorescent materials of the two first material parts in any adjacent two of said Q combinations having the same or different illuminant color, or
several R combinations, said third material part being a transparent material, which is located between any two adjacent R combinations, two A colored materials of the two first material parts in any adjacent two of said R combinations having the same or different color directly discernible by naked eyes.

15. An anti-counterfeiting fiber as in claim 1, wherein said slice or said part of slice contains at least one fine fiber with said anti-counterfeiting characteristics, the height of said fine fiber along the longitudinal axis direction of the strip-shaped fiber being equal to a height of the slice or the part of slice, said fine fiber being formed from three material parts distributed on a cutting surface, and being parallel with each other and extending along the longitudinal axis direction of said strip-shaped fiber, said three material parts including a fourth material part, a fifth material part and a sixth material part wherein a geometrical shape of said fine fiber on a surface located with said cutting surface contains at least one of the following structures:
structure 1: straight line form; or
structure 2: circular-arc form having a substantially uniform arc radius that subtends an angle equal to or less than π radians; or
structure 3: circular-arc form having a substantially uniform arc radius that subtends an angle more than π radians and less than 2π radians; or
structure 4: non-occluded circular-arc form having an arc radius that varies along the length thereof; or
structure 5: non-occluded bended form; or
structure 6: circular ring form with a substantially uniform arc radius; or
structure 7: ring form having an arc radius that varies along the length thereof; or
structure 8: polygon ring form.

16. An anti-counterfeiting fiber as in claim 15, wherein there are several material sectors distributed along the length direction of any one of said material parts, wherein;
at least two of said several material sectors are colored materials with different colors directly discernible by naked eyes, or
at least one of said several material sectors is a colorless transparent material and at least another of said several material sectors is a colored material, or
at least two of said several material sectors are fluorescent materials with different illuminant colors.

17. An anti-counterfeiting fiber as in claim 15, wherein:
said fourth material part contains A fluorescent material, said fifth material part is a shelter layer for exciting light, and said sixth material part contains B fluorescent material, wherein there is an obvious visual difference between the A fluorescent material and the B fluorescent material in illuminant color, said fifth material part being located between the fourth material part and the sixth material part, said fourth material part the fifth material part and the sixth material part forming S combination; or
said fourth material part contains A colored material, said fifth material part is a white shelter layer for visible light, and said sixth material part contains B colored material, wherein there is an obvious difference between the A colored material and the B colored material in colors which can be directly identified by naked eyes, said fifth material part being located between the fourth material part and the sixth material part, said fourth material part, the fifth material part and the sixth material part forming T combination; or
said fourth material part contains A colored material, said fifth material part (6₄₂) is a transparent material, and said sixth material part contains B colored material, wherein there is an obvious difference between the A colored material and the B colored material in colors which can be directly identified by naked eyes, said fifth material part being located between the fourth material part and the sixth material part, said fourth material part, the fifth material part and the sixth material part forming U combination.

18. An anti-counterfeiting fiber as in claim 17, wherein:
said fine fiber is formed from material parts distributed on cutting surfaces, and being parallel with each other and extending along the longitudinal axis direction of the strip-shaped fiber, said several material parts including a seventh material part and:
several S combinations, said seventh material part being located between two of any adjacent S combinations; or
several T combinations, said seventh material part being located between two of any adjacent T combinations; or
several U combinations, said seventh material part being located between two of any adjacent U combinations,
wherein the seventh material part is a transparent material.

19. (canceled)

20. An anti-counterfeiting paper, wherein said anti-counterfeiting paper contains said anti-counterfeiting fibers as in claim 1.

21. (canceled)

22. A manufacture method of the anti-counterfeiting fiber as in claim 1, said manufacture method comprising:
A. preparing the strip-shaped fiber, said strip-shaped fiber comprises a specific structure along the length direction thereof, providing the anti-counterfeiting characteristics to said part of slice;
B. cutting the strip-shaped fiber along the transversal surface or the oblique section into the slice in sheet;
C. removing a support part of said slice, the residual part of slice having said anti-counterfeiting characteristics, and said part of slice is being the anti-counterfeiting fiber.

23-25. (canceled)

26. An anti-counterfeiting fiber as in claim 12, wherein:
said first material part contains A fluorescent material and said second material part contains B fluorescent material, the A fluorescent material and the B fluorescent material having an obvious visual difference in illuminant colors, said first material part and the second material part forming P combination, or said first material part contains A fluorescent material and said second material part is a shelter layer for exciting light, said first material part and the second material part forming Q combination, or
said first material part contains A colored material and said second material part is a white shelter layer for visible light, said first material part and the second material part forming R combination, or
said first material part contains A colored material and said second material part is a transparent material, said first material part and the second material part forming M combination.

27. An anti-counterfeiting fiber as in claim 26, wherein:
said fine fiber is formed from several material parts distributed on cutting surfaces, and being parallel with each other and extending along the longitudinal axis direction of the strip-shaped fiber, said several material parts including a third material and:
several P combinations, said third material part being a material not obstructing exciting light, which is located between any two adjacent P combinations, or
several Q combinations, said third material part being a material not obstructing exciting light, which is located between any two adjacent Q combinations, two A fluorescent materials of the two first material parts in any adjacent two of said Q combinations having the same or different illuminant color, or
several R combinations, said third material part being a transparent material, which is located between any two adjacent R combinations, two A colored materials of the two first material parts in any adjacent two of said R combinations having the same or different color directly discernible by naked eyes.

28. An anti-counterfeiting fiber as in claim 16, wherein:
said fourth material part contains A fluorescent material, said fifth material part is a shelter layer for exciting light, and said sixth material part contains B fluorescent material, wherein there is an obvious visual difference between the A fluorescent material and the B fluorescent material in illuminant color, said fifth material part being located between the fourth material part and the sixth material part, said fourth material part, the fifth material part and the sixth material part forming S combination; or
said fourth material part contains A colored material, said fifth material part is a white shelter layer for visible light, and said sixth material part contains B colored material, wherein there is an obvious difference between the A colored material and the B colored material in colors which can be directly identified by naked eyes, said fifth material part being located between the fourth material part and the sixth material part, said fourth material part, the fifth material part and the sixth material part forming T combination; or
said fourth material part contains A colored material, said fifth material part is a transparent material, and said sixth material part contains B colored material, wherein there is an obvious difference between the A colored material and the B colored material in colors which can be directly identified by naked eyes, said fifth material part being located between the fourth material part and the sixth material part, said fourth material part, the fifth material part and the sixth material part forming U combination.

29. An anti-counterfeiting fiber as in claim 28, wherein:
said fine fiber is formed from several material parts distributed on cutting surfaces, and being parallel with each other and extending along the longitudinal axis direction of the strip-shaped fiber, said several material parts including a seventh material part and:
several S combinations, said seventh material part being located between two of any adjacent S combinations; or
several T combinations, said seventh material part being located between two of any adjacent T combinations; or
several U combinations, said seventh material part being located between two of any adjacent U combinations,
wherein the seventh material part is a transparent material.
